(19) United States
(12) Patent Application Publication
(10) Pub. No.: US 2024/0024838 A1
(43) Pub. Date: Jan. 25, 2024

(54) PROGRAMMING NUCLEATION AND GROWTH IN COLLOIDAL CRYSTALS

(71) Applicant: NORTHWESTERN UNIVERSITY, Evanston, IL (US)

(72) Inventors: Chad A. Mirkin, Wilmette, IL (US); Kaitlin Marie Landy, Evanston, IL (US); Kyle Joseph Gibson, Evanston, IL (US)

(21) Appl. No.: 18/224,997

(22) Filed: Jul. 21, 2023

Related U.S. Application Data
(60) Provisional application No. 63/391,554, filed on Jul. 22, 2022.

(51) Int. Cl. B01J 13/00; B22F 1/054; B22F 1/17

(52) U.S. Cl. CPC B01J 13/0043; B22F 1/054; B22F 1/17; B82Y 40/00

(57) ABSTRACT

A method of making colloidal crystals using seed programmable atom equivalents (PAEs) and growth programmable atom equivalents (PAEs) for at least two stage growth. The seed and growth PAEs each include nanoparticles functionalized with oligonucleotides with sticky ends. Seed PAEs have sticky ends adapted to hybridize to each other to form a first duplex, and growth PAEs have sticky ends adapted to hybridize to a respective ones of the seed PAEs and to each other to form second, third, and fourth duplexes. Using base mismatches in the sticky ends of the growth PAEs and a two stage cooling, the first duplex having a higher melting temperature than the other duplexes nucleate the seed PAEs as seeds in a first stage and remaining duplexes form in a second lower temperature stage for growth on the seeds.

### CROSS-REFERENCE TO RELATED APPLICATION

The benefit of priority to U.S. Provisional Application No. 63/391,554 filed Jul. 22, 2022, is hereby claimed and the disclosure is incorporated herein by reference in its entirety.

### STATEMENT OF GOVERNMENT SUPPORT

This invention was made with support under grant FA9550-17-1-0348 awarded by the Air Force Office of Scientific Research. The government has certain rights in the invention.

### FIELD

The disclosure relates to a method for forming colloidal crystals and more particularly to a two-stage method for colloidal crystal formation.

### BACKGROUND

Nanoparticles assembled using DNA into colloidal crystals have been shown to construct over 50 different lattice symmetries with tunable lattice parameters and independent nanoparticle identities. Recently, the focus of these assemblies with programmable atom equivalents (PAEs) has shifted to also include control over the crystal habit. While the formation of defined habits is not exclusive to DNA-mediated assembly, most common self-assembly techniques such as evaporative preparations, are not capable of forming habits. The formation of well-defined crystal habits can be explained through the minimization of surface energy, a feature which is easily accessed due to the highly tunable and programmable nature of DNA. A consequence of the synthesis of faceted crystal habits is the interest in controlling the size of crystals, which dictates the properties of the crystals and processing of crystals in macroscopic materials. However, the difficulty in harnessing control over crystal size stems from the simultaneity of the nucleation and growth steps during the homogeneous slow-cooling crystallization process.

Colloidal crystals comprised of PAEs have size- and shape-dependent properties and control over nanoscale features that are analogous to their nanoparticle counterparts. For noble metal nanoparticles, size and shape control has become a hallmark of the syntheses, largely enabled by the utilization of seed-mediated growth to control size and shape outcomes of the nanoparticles.

### SUMMARY

Employing a seed-mediated approach to the synthesis of nanoparticles grants a slower and more controlled growth process and eliminates unwanted secondary nucleation events. Homogeneous synthetic techniques are unable to separate the growth and nucleation steps during synthesis meaning both occur throughout the synthetic process, leading to a product that is polydisperse in size. Despite the advantages of heterogeneous syntheses, examples for colloidal crystals remain few and are only limited to surface-based methods. There are no examples of colloidal crystals synthesized using an analogous seed-mediated approach.

Methods of the disclosure provide a DNA-mediated process for programmable PAE colloidal crystals that occurs in a two-step manner. The DNA contains two pairs of separate but overlapping sticky ends that each have a distinct melting transition. This allows for the initial “seed” synthesis followed by a subsequent heterogeneous “growth” step occurring all in one solution.

### BRIEF DESCRIPTION OF THE DRAWINGS

FIGS. 1A and 1B are schematic illustrations for two-stage nanoparticle assembly using DNA. FIG. 1A shows a complementary PAE design, where each nanoparticle core is functionalized to an anchor DNA strand containing a recognition region that hybridizes with a linker DNA strand containing a sticky end overhang. Hybridization of complementary A and B sticky end sequences drives PAE assembly. FIG. 1B shows two sets of complementary PAEs, referred to as seed and growth PAEs, are combined in one assembly solution. The seed PAEs have a stronger sticky end interaction and nucleate first, followed by heterogeneous growth of the remaining PAEs with weaker sticky end interaction strengths containing the base mismatches. The nucleotides in A* and B* designed to always be involved in base mismatching are shown in red, and the pair mismatches are shown underlined.

FIGS. 2A to 2D show UV-vis and SAXS characterization during the slow cooling assembly process. FIG. 2A is a graph showing UV-vis characterization of complementary PAE pairs, where all PAE pairs exhibit a characteristic sharp melting transition shown by the decrease in extinction at the gold nanoparticle core LSPR wavelength of 520 nm. A and B seed PAEs (top) have the highest DNA melting transition and the other three complementary pairs containing either growth A* or B* DNA sequences with a single base mismatch have lower DNA melting transitions. Red: heating, Blue: cooling. FIG. 2B is a graph showing UV-vis melting temperature characterization of a mixture of seed and growth PAEs with a 1:2 ratio. Two distinct melting transitions are observed, corresponding to the melting temperatures of the seed and growth PAEs. Red: heating, Blue: cooling. FIG. 2C is a graph showing in situ SAXS characterization of normalized (110) peak intensity plotted against temperature. The increase in peak intensity indicates the onset of crystallinity. Red: Seed PAEs, Blue: Growth PAEs, Black: Both PAEs. FIG. 2D is a graph showing stacked overlay of the in situ SAXS temperature curves for the sample containing both PAEs, corresponding to the black curve from c.

FIGS. 3A to 3C show characterization of crystal size uniformity. FIG. 3A shows crystals assembled using standard homogeneous growth (A* and B* PAEs only) and FIG. 3B shows crystals assembled via seeded growth. Scale bars: 1 μm. FIG. 3C is a histogram of crystal sizes measured using a python script, n=# of crystals.

FIG. 4A is a schematic depicting the addition of a temperature hold (T_{hold}) between the Tₘ of the seed PAEs and the Tₘ of the growth PAEs during the slow cooling process.

FIG. 4B includes graphs showing size distributions and SEM images of crystals assembled with hold temperatures at Tₘ 1 (45.5° C., red), below Tₘ 1 and above Tₘ 2 (43.3° C., purple), at Tₘ 2 (39.5° C., blue), and below Tₘ 2 (37.3° C., green). Scale bars: 1 μm.

FIGS. 5A and 5B show colloidal crystals with different sizes assembled by varying growth PAE concentration. Seed PAE concentrations were held constant at 150 pM with total concentrations of 300 pM, 1 nM, 2.5 nM, 4 nM. FIG. 5A are graphs of the crystal size distributions and FIG. 5B is SEM imaging of the colloidal crystals. Scale bars: 500 nm.

FIGS. 6A to 6C are SAXS patterns and simulations for Au PAEs with different DNA. FIG. 6A shows seed PAEs only (lattice parameter a=40.0 nm), FIG. 6B shows seeded growth (a=40.7 nm), and FIG. 6C shows growth PAEs only (a=41.3 nm).

FIGS. 7A and 7B show in-situ SAXS patterns acquired while cooling control assemblies at a rate of 0.2° C./min. FIG. 7A shows seed PAEs only, FIG. 7B shows growth PAEs only.

FIGS. 8A to 8F illustrate a watershed algorithm for extracting crystal size information. FIG. 8A is the original SEM image taken at 10,000× magnification. FIG. 8B is the cropped image and heat map based on the distance transform function to identify local minima and maxima of the image. FIG. 8C shows the background region, crystal region, and “unknown” boundary region defined from the distance transform values. These markers are the inputs for the final watershed algorithm. FIG. 8D shows shapes identified from the watershed algorithm. FIG. 8E shows the boundaries drawn on the original SEM image of identified shapes. FIG. 8F shows the major and minor axis of approximated ellipsoids for each identified object.

FIGS. 9A to 9C show a comparison of hand measurements and classification to the automated program. FIG. 9A is a graph of the size distributions of hand measurements done on ImageJ. 104 crystals were measured and are indicated by black lines on the SEM image. FIG. 9B is a graph of the size distributions of automated identification and measurements made by the python script. Of the shapes measured, 91 passed the thresholding criteria and were determined to be crystals. FIG. 9C is a confusion matrix to assess the performance of the program and sequential thresholding criteria as a very basic two-class classification model for determining whether a shape is a crystal (positive) or not a crystal (negative).

FIG. 10 shows additional SEM images of crystals assembled via seeded growth with a 12 hour temperature hold at 35° C. (T_{hold}=Tₘ 2). Scale bars: 1 μm.

FIG. 11 shows additional SEM images of crystals assembled via seeded growth without the use of a 12 hour temperature hold. Scale bars: 1 μm.

FIG. 12 shows additional SEM images of control crystals containing only A*+B* PAEs. Scale bars: 1 μm.

FIG. 13 includes graphs of the crystal size distributions for control assemblies containing only A*+B* PAES (top), seeded growth without the addition of a 12 hour temperature hold during slow cooling (middle), and seeded growth with a 12 hour hold at Tₘ2 (bottom).

FIG. 14 shows additional SEM images of crystals assembled with a 12 hour temperature hold at 45.5° C. (T_{hold}=Tₘ 1). Scale bars: 1 μm.

FIG. 15 shows additional SEM images of crystals assembled with a 12 hour temperature hold at 44.3° C. (Tₘ 1>T_{hold}>Tₘ 2). Scale bars: 1 μm.

FIG. 16 shows additional SEM images of crystals assembled with a 12 hour temperature hold at 43.3° C. (Tₘ 1>T_{hold}>Tₘ 2). Scale bars: 1 μm.

FIG. 17 shows additional SEM images of crystals assembled with a 12 hour temperature hold at 41.9° C. (Tₘ 1>T_{hold}>Tₘ 2). Scale bars: 1 μm.

FIG. 18 shows additional SEM images of crystals assembled with a 12 hour temperature hold at 40.9° C. (Tₘ 1>T_{hold}>Tₘ 2). Scale bars: 1 μm.

FIG. 19 shows additional SEM images of crystals assembled with a 12 hour temperature hold at 39.5° C. (T_{hold}=Tₘ 2). Scale bars: 1 μm.

FIG. 20 shows additional SEM images of crystals assembled with a 12 hour temperature hold at 39° C. (Tₘ 2>T_{hold}). Scale bars: 1 μm.

FIG. 21 shows additional SEM images of crystals assembled with a 12 hour temperature hold at 38.3° C. (Tₘ 2>T_{hold}). Scale bars: 1 μm.

FIG. 22 shows additional SEM images of crystals assembled with a 12 hour temperature hold at 37.3° C. (Tₘ 2>T_{hold}). Scale bars: 1 μm.

FIG. 23 includes graphs showing the size distributions of crystals assembled with a 12 hour temperature hold at various temperatures not shown in FIG. 4.

FIG. 24 is SEM images of crystals assembled with different fractions of seed PAEs, but the same total PAE concentration. (a) 1/16%, (b) 1%, (c) 16%, and (d) 50% seed PAEs with 1 nM total PAE concentration during assembly. Scale bars: 1 μm.

FIG. 25 is SAXS patterns of seeded assemblies with 200 pM seed PAEs and increasing concentrations of growth PAEs. PAE core: 20 nm Au.

FIG. 26 shows additional SEM images of crystals assembled via seeded growth with a seed PAE concentration of 150 pM and total PAE concentration of 200 pM. Scale bars: 1 μm.

FIG. 27 shows additional SEM images of crystals assembled via seeded growth with a seed PAE concentration of 150 pM and total PAE concentration of 1 nM. Scale bars: 1 μm.

FIG. 28 shows additional SEM images of crystals assembled via seeded growth with a seed PAE concentration of 200 pM and total PAE concentration of 2 nM. Scale bars: 1 μm.

FIG. 29 shows additional SEM images of crystals assembled via seeded growth with a seed PAE concentration of 200 pM and total PAE concentration of 3 nM. Scale bars: 1 μm.

FIG. 30 includes SEM images of control crystals assembled with total PAE concentrations of 300 pM. Scale bars: 1 μm.

FIG. 31 includes SEM images of control crystals assembled with total PAE concentrations of 3 nM. Scale bars: 1 μm.

FIG. 32 includes graphs of the size distributions of control crystals assembled with total A*+B* PAE concentrations of 0.3 nM and 4 nM.

FIG. 33 is a graph of UV-vis melting temperature for Au PAEs with seed or growth DNA measured at 520 nm compared to Ag PAEs with seed or growth DNA measured at 400 nm; bottom line: heating, top line: cooling.

FIGS. 34A and 34B shows control assemblies with complementary Au and Ag PAEs. FIG. 34A is a UV-Vis melting curves showing a single transition for Au A+Ag B between the melting transitions of single component samples. FIG. 34B includes EDS maps showing Au and Ag signal throughout the crystal as expected based on the CsCl lattice structure. Scale bar: 250 nm.

FIGS. 35A to 35D show additional EDS map with lower magnification showing exclusively core-shell crystal products. FIG. 35A is a Z-contrast electron image, FIG. 35B is an overlay of Au and Ag signal, FIG. 35C is the Ag signal, and FIG. 35D is the Au signal. Scale bar: 500 nm.

### DETAILED DESCRIPTION

Methods in accordance with the disclosure provide for a two-stage process for formation of colloidal crystals from oligonucleotide functionalized nanoparticles as programmable atom equivalents (PAEs). Methods of the disclosure advantageously provide a method in which an at least two-stage growth process involving nucleation of seeds followed by a growth stage can be achieved as a one-pot synthesis. Methods of the disclosure can also advantageously provide for synthesis of core-shell crystals, which similarly can be process in a one-pot synthesis. Methods of the disclosure can include a multi-stage growth process, for example, to result in a multi-shell structure, where a growth phase is provided for each shell. Methods of the disclosure can provide a slower and more controlled growth process. Methods of the disclosure can reduce or eliminate unwanted secondary nucleation events.

Methods of the disclosure include admixing in solution seed and growth PAEs and cooling in at least two stages to induce seed formation followed by crystallization on the seeds to thereby grow the colloidal crystals. Multiple different growth PAEs can be included, for example, to grow a multi-shell structure.

The seed PAES can include a first nanoparticle functionalized with a first oligonucleotide and a second nanoparticle functionalized with a second oligonucleotide. The first and second oligonucleotides each have sticky ends that are adapted to hybridize to one another to form a first duplex. The growth PAEs can include a third nanoparticle functionalized with a third oligonucleotide and a fourth nanoparticle functionalized with a fourth oligonucleotide. The third oligonucleotide has a sticky end that has at least one base mismatch as compared to the sticky end of the first oligonucleotide. The fourth oligonucleotide has a sticky end that has at least one base mismatch as compared to the sticky end of the second oligonucleotide. The sticky end of the third oligonucleotide is adapted to hybridize to the sticky end of second oligonucleotide to form a second duplex. The sticky end of the fourth oligonucleotide is adapted to hybridize to the sticky end of the first oligonucleotide to from a third duplex. The sticky ends of the third and fourth oligonucleotides are adapted to hybridize to form a fourth duplex.

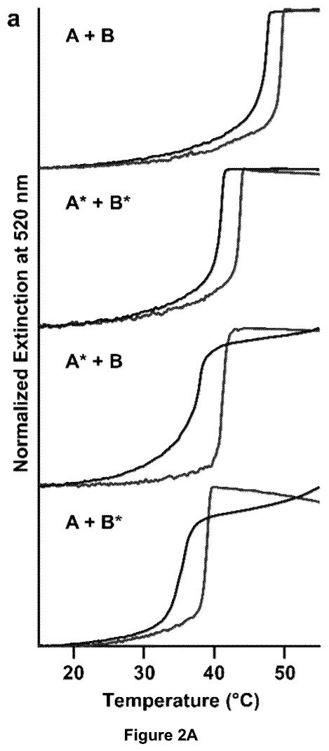

As a result of the at least one base mismatches in the sticky ends of the third and fourth oligonucleotides, the first duplex has a higher melting temperature than the melting temperature of each of the second, third, and fourth duplexes. For example, the first duplex can have a higher melting temperature as compared to the second, third, and fourth duplexes by virtue of having no pair mismatches or having few pair mismatches as compared to the second, third, and fourth duplexes. For example, referring to FIG. 2, two sticky ends absent of any base mismatches can have a higher melting temperature by about 10° C. as compared to a duplex having any single base mismatch. Base mismatches can be selected to achieve a desired difference in melting temperature. For example, the first duplex can have a melting temperature that is about 5° C. to about 20° C. higher than the second, third, and fourth duplex. Where more than two stage growth is desired, such as in multi-shell structures as described herein, the mismatches can be selected to tailor the differences in melting temperature to obtain the selective crystallization through the cooling stages.

Any number of cooling stages can be used herein depending on the number of different growth phases desired. For example, each cooling stage can correspond to melting temperatures of the various duplexes able to form in solution to have selected crystallization with the cooling stages to thereby crystallize specific ones of the nanoparticles in solution.

The reduction of temperature can be a continuous cooling through the stages, such that the temperature is lowered continuously to process through the cooling stages. The reduction of temperature can be stepped, such that a temperature during the cooling is held for a duration of time during one or more of the cooling stages. A combination of continuous cooling and holds can also be used herein, such that the temperature is cooled through one or more stages continuously with one or more holds in other ones of the stages. The temperature can be cooled from a starting temperature of the admixture to below the lowest of the melting temperature of the duplex. For example, crystallization can occur between 20° C. and 70° C. for some systems.

The seed and growth nanoparticles can be functionalized with an oligonucleotide having an anchor sequence and a linker sequence, the linker sequence having the sticky end. Alternatively, the seed and growth nanoparticles can be functionalized with an anchor sequence and a linker sequence can be admixed with the solution of the nanoparticles. The anchor sequence and the linker sequence are adapted to hybridize to thereby form the nanoparticles functionalized with an oligonucleotide having the sticky ends as described herein and hybridization for crystallization can be induced upon cooling in the first and second stages as described herein. In such embodiments, the admixture can include first, second, third, and fourth nanoparticles functionalized with first, second, third, and fourth anchor sequences, respectively, and first, second, third, and fourth linker sequences. Each linker sequence comprises an overhang defining the sticky end. As discussed above, the third linker has an overhang with at least one base mismatch as compared to the first linker overhang and the fourth linker has an overhang with at least one base mismatch as compared to the second linker. The respective anchor and linker sequences are adapted to hybridize to form the first, second, third, and fourth nanoparticles functionalized with the respective oligonucleotides with a sticky end as described herein.

The method induces seed formation in a first stage cooling in which the admixture is cooled to cause formation of the first duplex, which results in nucleation of seeds formed of the first and second nanoparticles. The temperature during the first stage cooling is at or lower than the melting temperature of the first duplex and higher than the melting temperature of each of the second, third, and fourth duplexes

The method induces growth on the seeds in a second stage cooling under conditions sufficient to cause one or more of the second, third, and fourth duplexes to form resulting in crystallization on the seeds to thereby grow the colloidal crystals on the seeds. The temperature during the second stage cooling is at or lower than the melting temperature of one or more of the second, third, and fourth duplexes.

The difference in melting temperature between the interaction of the first and second oligonucleotides to form the first duplex gives rise to the two-step process. During the slow-cooling process of crystallization, the higher melting temperature of the first duplex will nucleate the first and second nanoparticle, thereby forming seeds in solution. The subsequent growth step occurs when the remaining nanoparticles crystallize onto the already formed nucleated seeds in solution as the temperature is lowered through the second stage cooling.

The first, second, third, and fourth nanoparticles can each be formed of the same material or can be formed of different materials. For example, the first and second nanoparticles can be formed of a first material, while the third and fourth nanoparticles are formed of a second material. This would result in formation of a core shell structure in which the core is a different material than the shell.

Any suitable nanoparticles to which an oligonucleotide can be attached can be used. For example, the nanoparticles can be metal, magnetic, dielectric, and/or quantum dots. For example, the nanoparticles can be gold and/or silver.

The nanoparticles can have any suitable shape or size. For example, the nanoparticles can have a diameter of about 5 nm to about 100, about 10 nm to about 50 nm, or about 25 nm to about 75 nm, or any values or ranges there between.

A ratio of a concentration of first and second nanoparticles functionalized with the first and second oligonucleotides, respectively to a concentration of the third and fourth nanoparticles functionalized with the third and fourth oligonucleotides, respective can be about 1:1 to 3:80 in some admixtures.

Crystals with rhombic dodecahedral habit with a body-centered cubic (BCC) lattice symmetry was prepared with the methods of the disclosure using gold nanoparticles of 15- and 20 nm diameters.

### Probing the Consequence of Base Mismatches on Colloidal Crystal Melting Temperature

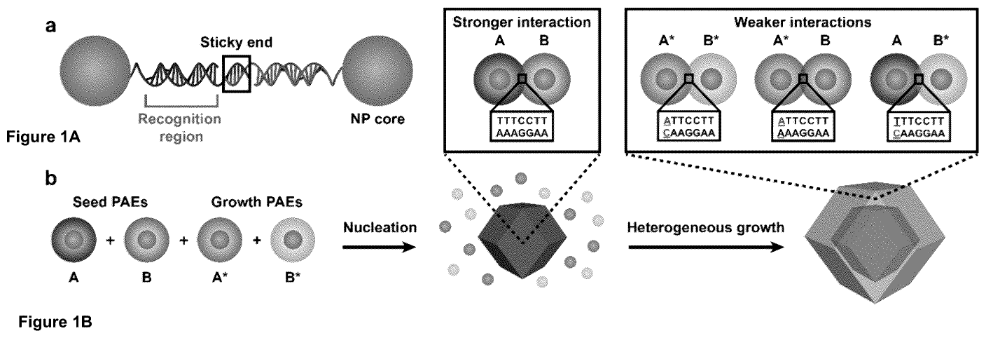

To characterize the effect that base mismatches in the sticky ends have on the melting transitions, UV-vis absorbance measurements were performed on the various combinations of PAEs as they were slow-cooled. Sequences of the oligonucleotides are shown in Table 1 below. The first and second oligonucleotides representing the pair of sticky ends absent of the base mismatches are denoted as A and B. The first duplex formed by these sticky ends predictably had the highest melting temperature (Tₘ=49.6° C.). The third and fourth oligonucleotides with sticky ends designed to always contain a base mismatch when hybridized are denoted A* and B*. Referring to FIG. 1B, the base mismatch is shown in a gray shade and the pair mismatched is underlined. The mismatch had a significantly lower melting temperature (Tₘ=43.6° C.). Because A and A* as well as B and B* differ by only a single base, each strand is capable of hybridizing to both versions of the complementary strand. The A* sticky end was designed with the mismatch at the 5′ end and the B* at the 3′ end (FIG. 1B); as a result, when hybridized each of the three lower Tₘ sticky end interactions (second, third, and fourth duplexes) contain exactly one base mismatch. In both A* and B as well as A and B* a similar melting temperature (Tₘ=41.4° C. and 39.0° C., respectively) was observed as the previously mentioned weaker interaction, A* and B*. The combined sample shows the presence of two distinct melting transitions in a single curve, (FIG. 2B) and each transition matches the measured melting transitions of the specific interaction strengths from FIG. 2A.

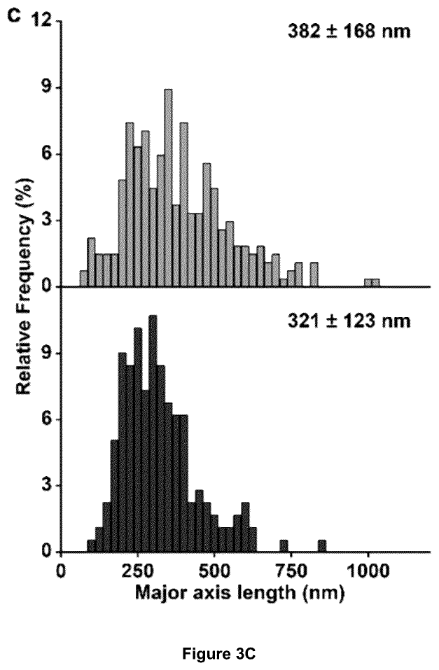

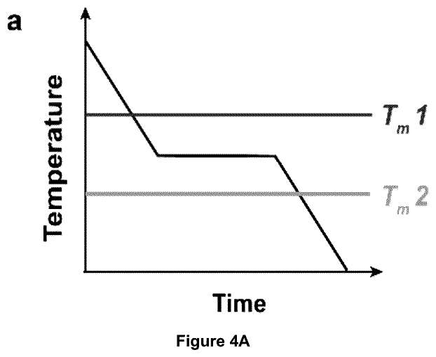

Small-angle X-ray scattering (SAXS) was also used to measure the melting transitions of each of the steps in the crystallization. As expected with the complementary sticky-end design, all crystals were indexed to standard BCC (FIG. 6). A heating stage for the samples was utilized to perform in situ slow-cooling temperature-based measurements. Spectra were collected every 1° C. as the sample was slow-cooled at a rate of 0.2° C./min. Form factors were collected and used as a baseline to generate structure factors. Then the intensities of the principal (110) peaks were normalized to the maximum intensity from each sample, and the values for each peak intensity were plotted against temperature to qualitatively assess the crystallization transitions of each sample (FIG. 2C-2D). For the control samples containing only A and B as well as only A* and B*, a single sharp transition showing the onset of crystalline peaks can be observed, similar to the melting transitions observed in the UV-vis experiments above (FIG. 2C and FIG. 7). For the two-step sample, two distinct transitions can be observed with a gradual increase in peak intensity between the two transitions.

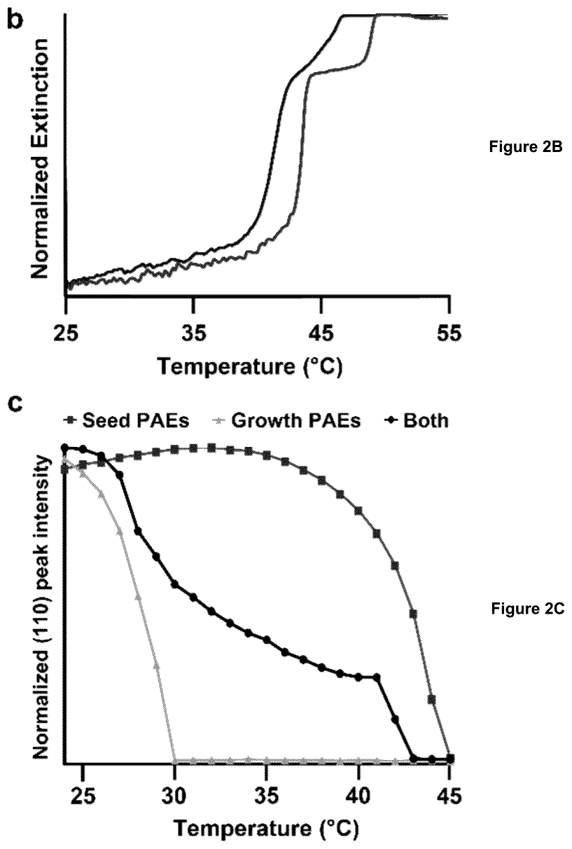

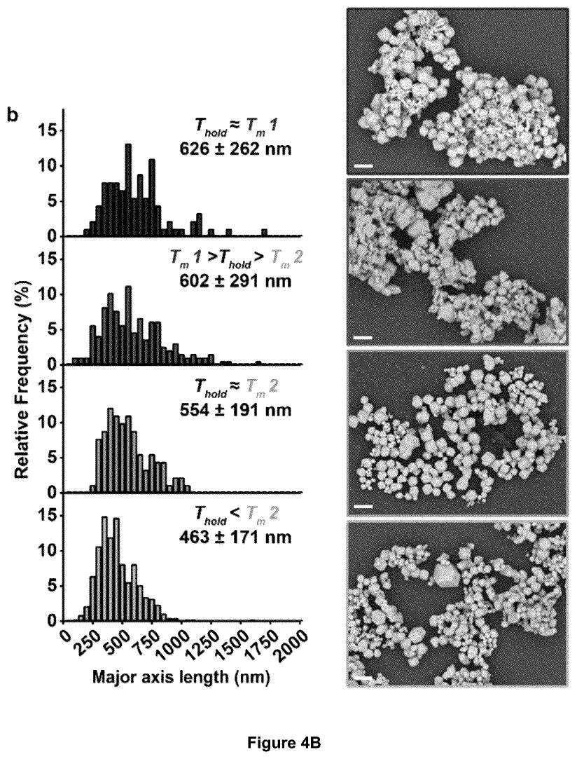

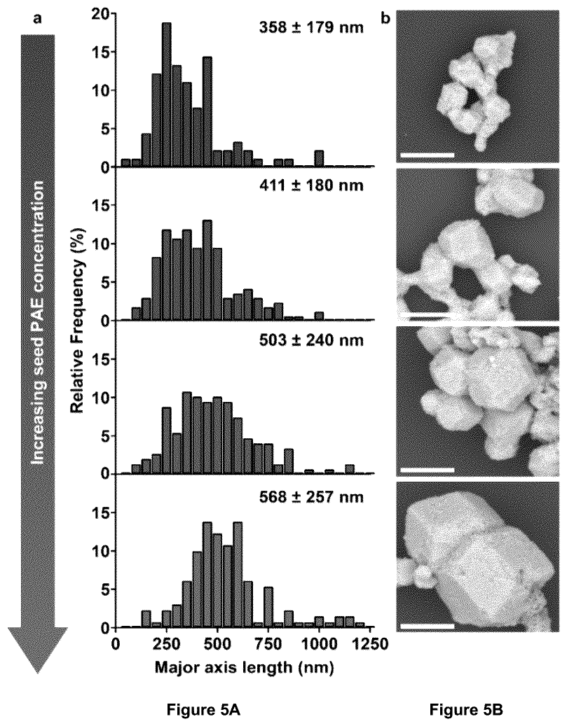

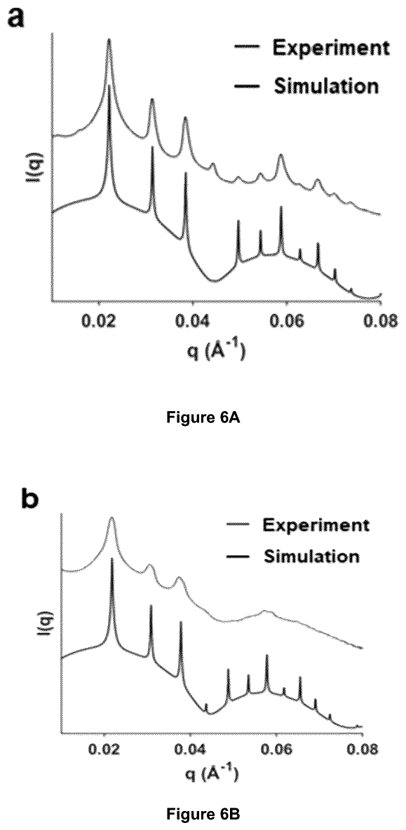

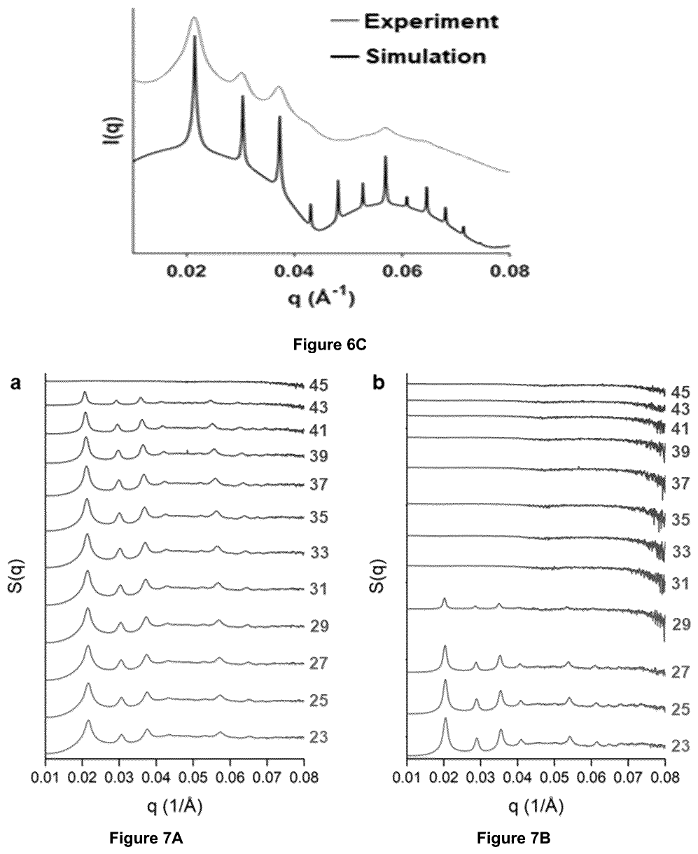

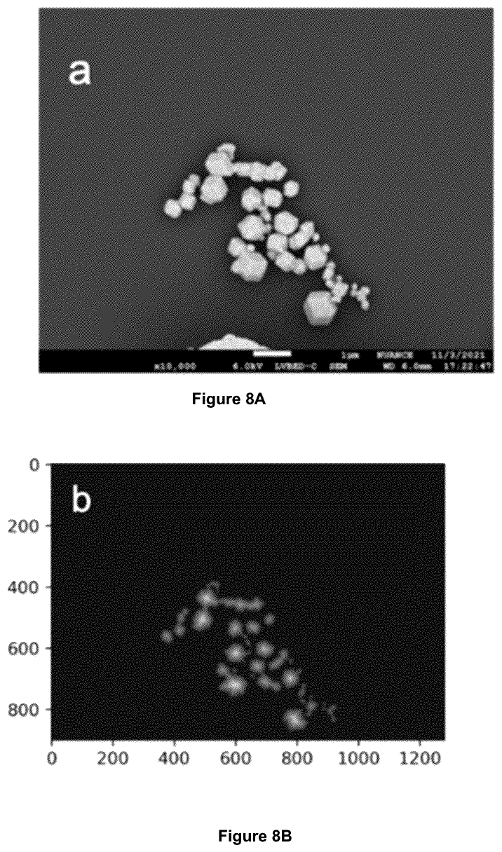

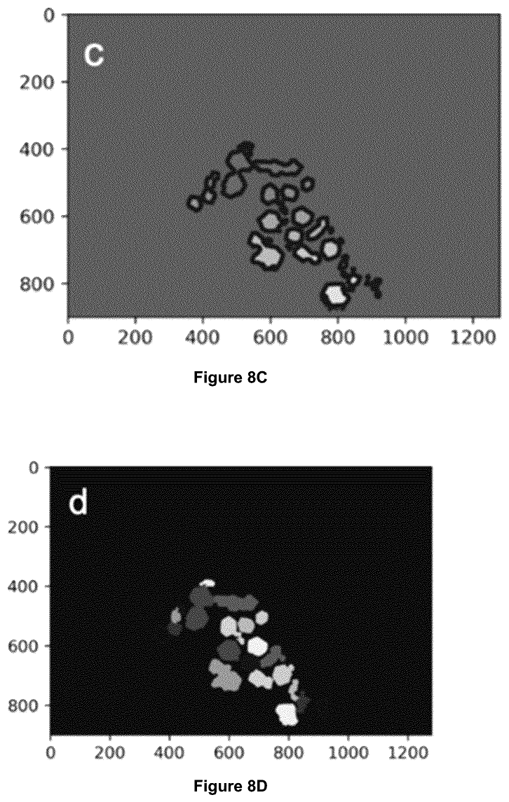

Electron micrograph images provide confirmation that the two-step mechanism leads to improved crystal uniformity. To give an automated and unbiased source of measurement data, a Python script was developed and used to threshold, define the boundary of, and measure the crystals from the micrograph images. A set of criteria was developed based on the measurement parameters to filter the correctly identified crystals measured by the script (FIG. 8). The automated data generated by the script was found to not differ in any significant way from samples hand-measured using ImageJ (FIG. 9). Crystals assembled with A* and B* sticky ends were assembled and used as a control to give a comparison to the two-step crystals. The crystals were measured using the automated script, and histograms of the measured crystals show vastly improved uniformity as indicated by the narrower distribution of sizes when the two-step growth process is employed (FIG. 3 and FIGS. 10-13).

### The Effect of a Temperature Hold During Slow-Cooling on Two-Stage Crystallization

The importance of slow-cooling on colloidal crystal formation and crystal habits is well-established in previous reports. Without intending to be bound by theory, it was believed that that extending the time at a specific temperature where heterogeneous growth can occur but secondary nucleation is not favorable would improve the uniformity of the crystals. The samples were slow-cooled at the standard cooling rate of 0.1° C./min and a 12-hour hold at various temperatures was introduced between the upper melting transition and several degrees below the lower melting transition. The crystal sizes and uniformities were analyzed for each hold temperature using the Python script.

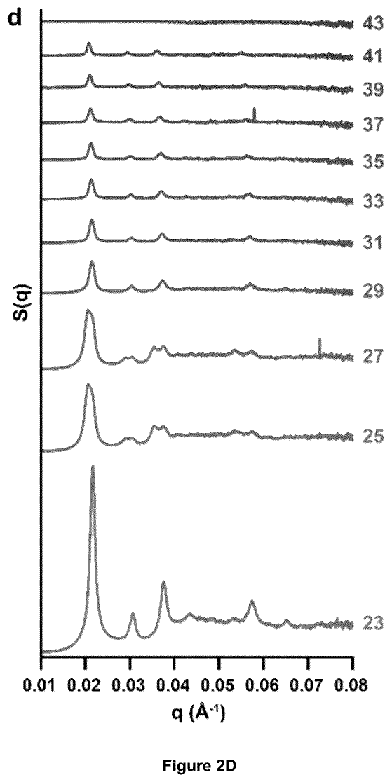

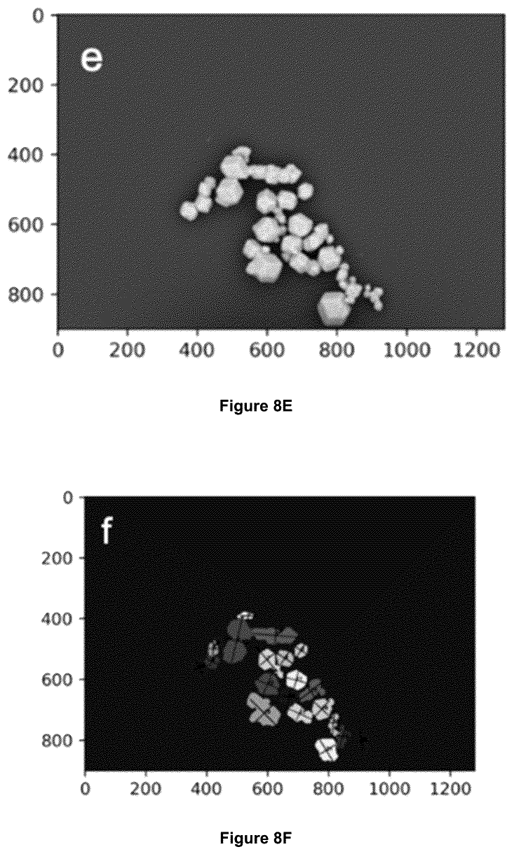

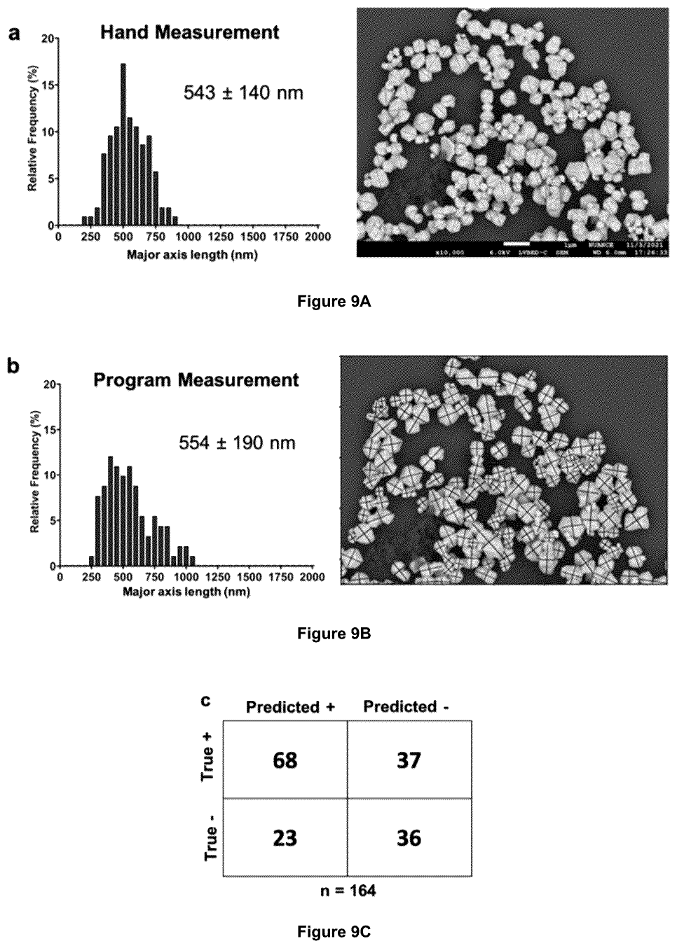

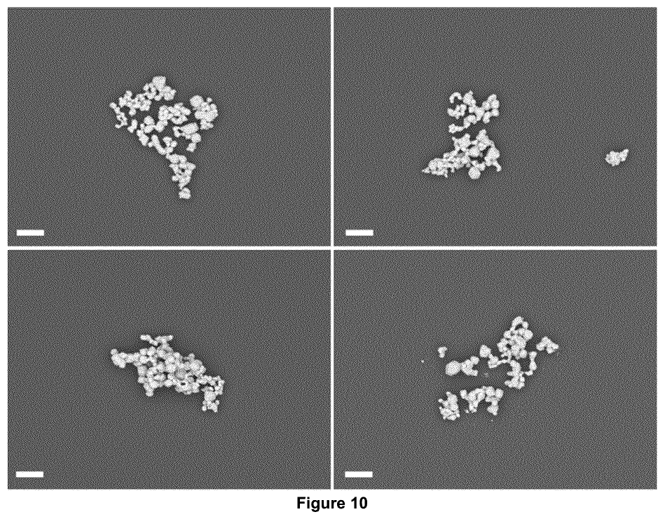

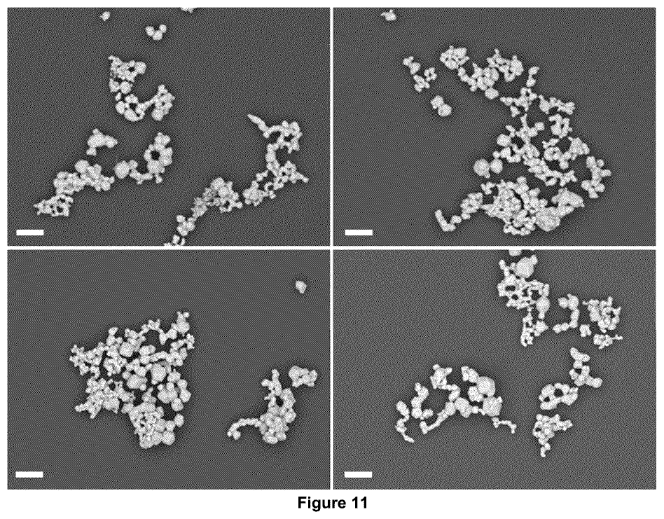

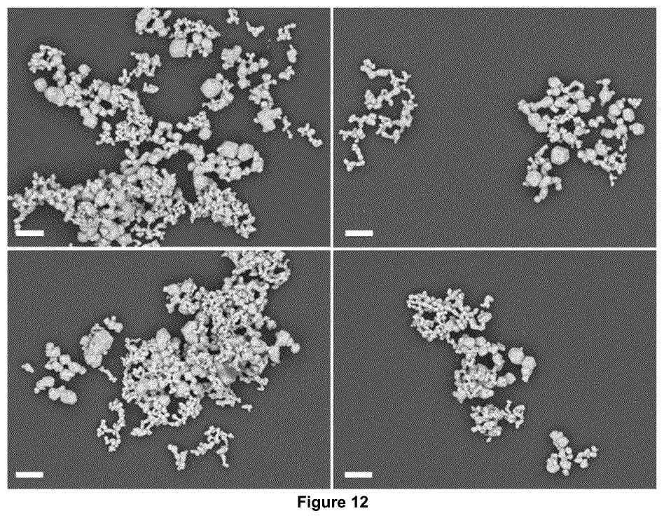

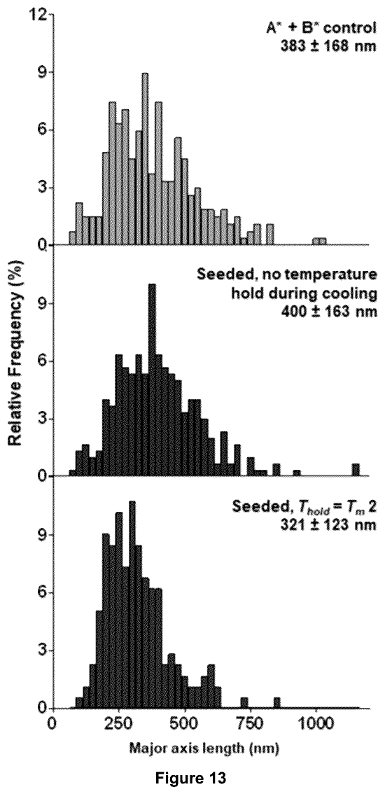

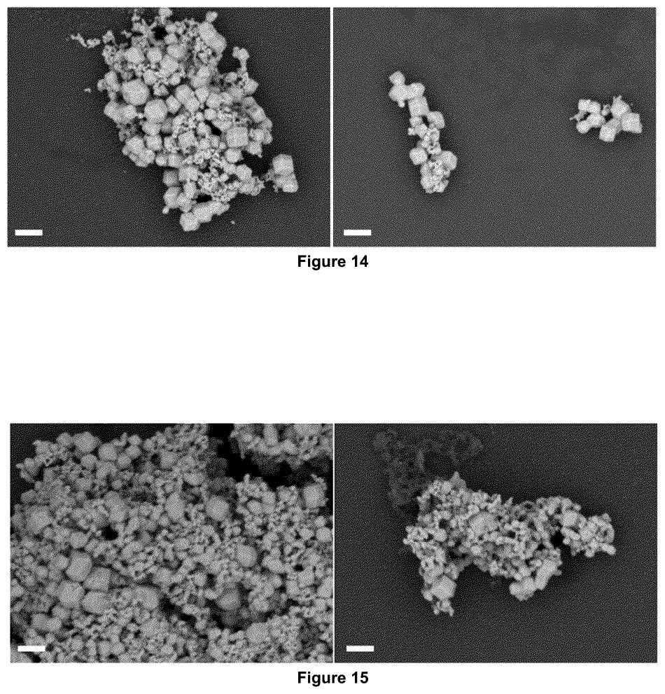

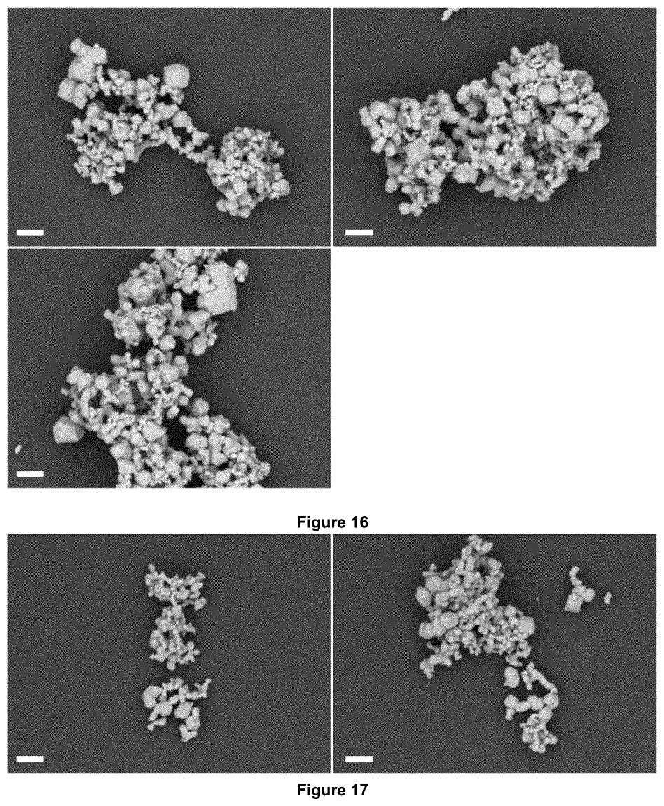

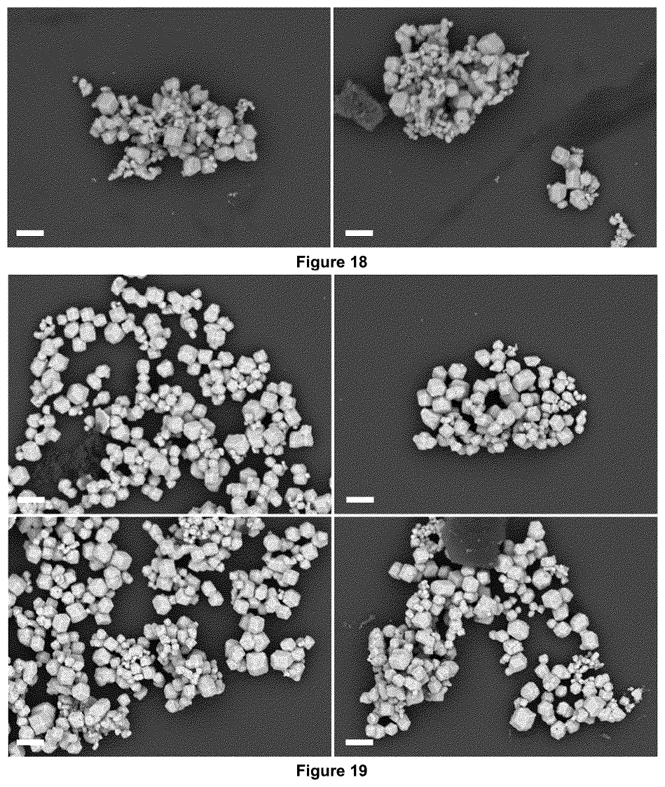

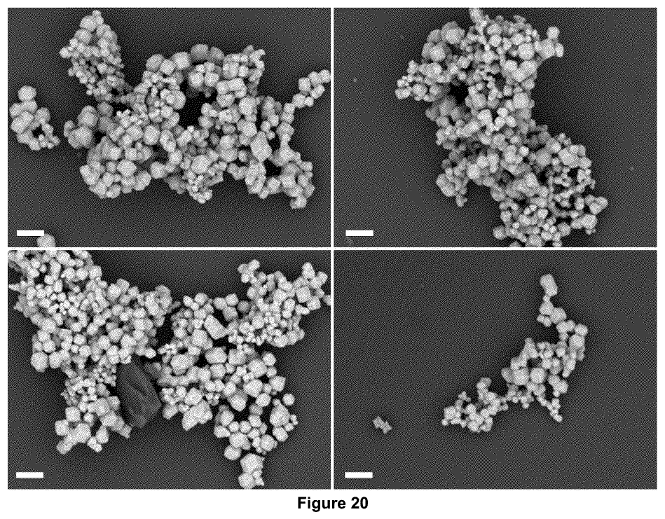

Samples with high temperature holds had higher polydispersity and size distributions shifted towards larger crystals. Many small crystallites below 100 nm in diameter are also observed via SEM when the hold temperature is close to the seed PAE melting temperature. These products are not properly identified due to poor segmentation by the Python script as a result of their small size, lack of defined facets, and frequent overlap. These aberrant crystals are filtered out by the classification criteria and therefore not included in the data set and would only further increase the measured polydispersity in these samples. Fewer of these products are observed as the hold temperature is decreased between the seed and growth PAE Tm (FIG. 14-18). The optimal temperature for the 12-hour hold was found to be at the lower melting transition (FIG. 4B) where the standard deviation of the crystal sizes was found to be lowest. Higher standard deviations were observed as the hold temperature was lowered further below the second melting transition. The size distribution in these samples shifts towards smaller products, which is consistent with secondary nucleation of the growth PAEs that can occur at these temperatures but have less time to grow to larger sizes. Overall, the 12-hour temperature hold was found to improve the uniformity when compared to not using a hold temperature (FIG. 19-23).

### Controlling the Size of Colloidal Crystal Through the Ratio of Seed PAEs to Growth PAEs

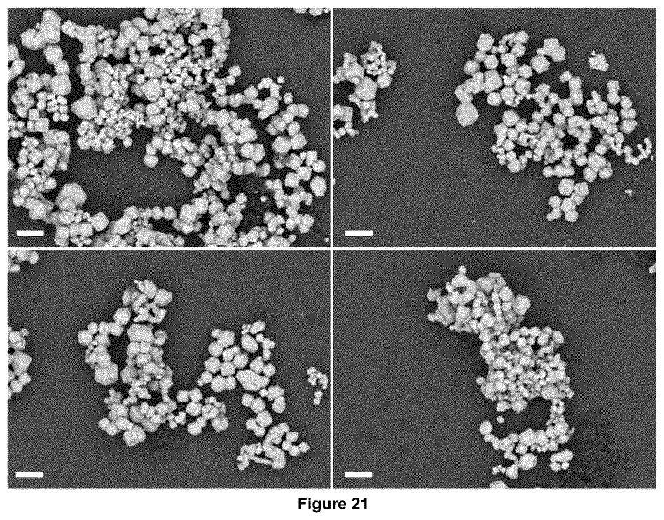

In traditional nanoparticle synthesis, the size of the nanoparticle product is often dictated by the ratio of metal precursor to nanoparticle seed. In practice, a range of nanoparticle sizes is often synthesized by keeping the metal precursor in all samples constant and varying the amount of nanoparticle seeds added to the growth solution so as to not disrupt other critical factors such as the ratio of reducing agent to precursor. In the two-step crystallization method of the disclosure, the concentration of crystal ‘seeds’ or nucleates present in any crystallization solution will be correlated in some way to the concentration of seed PAEs, but the exact relationship between the two concentrations depends on many factors. When the fraction of PAEs with seed DNA is varied but the total concentration of PAEs is held constant, no trend in crystal size can be observed over a wide range of seed fractions (FIG. 24). However, when the seed PAEs are held at a constant concentration and the amount of growth PAEs is varied relative to the seed PAEs, the product crystals could be tuned over a range of sizes.

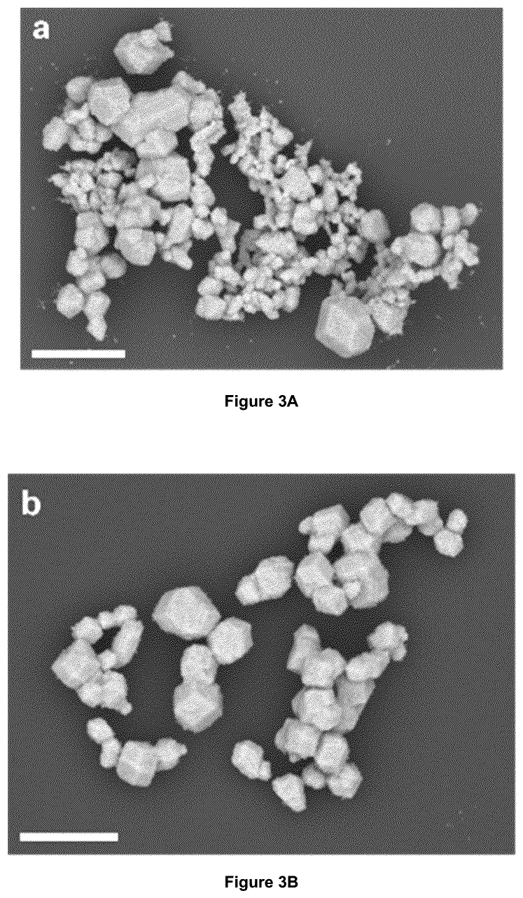

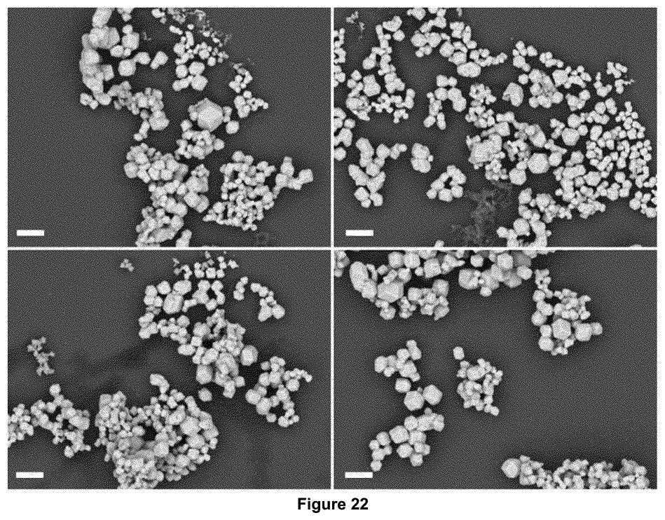

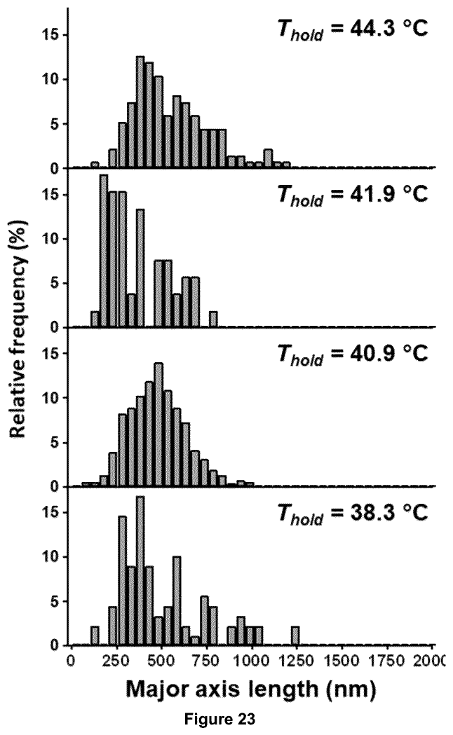

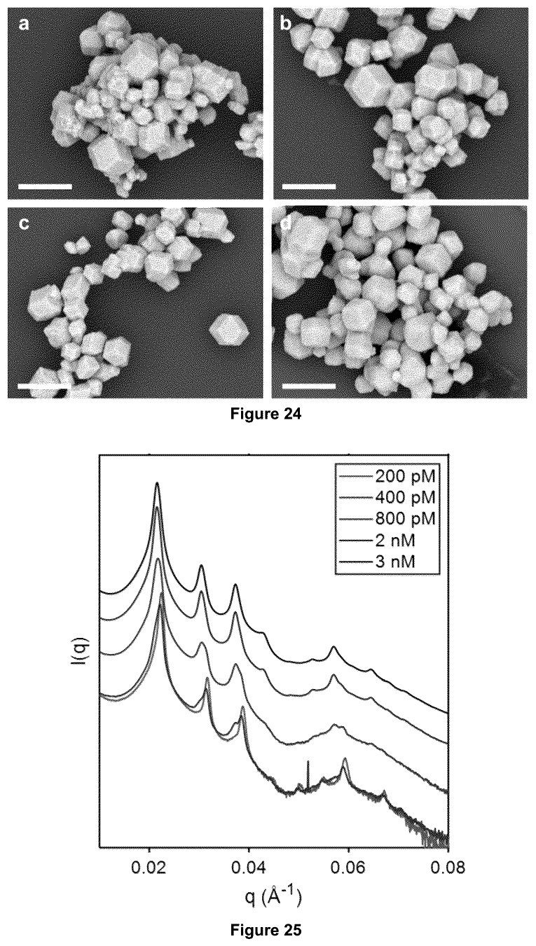

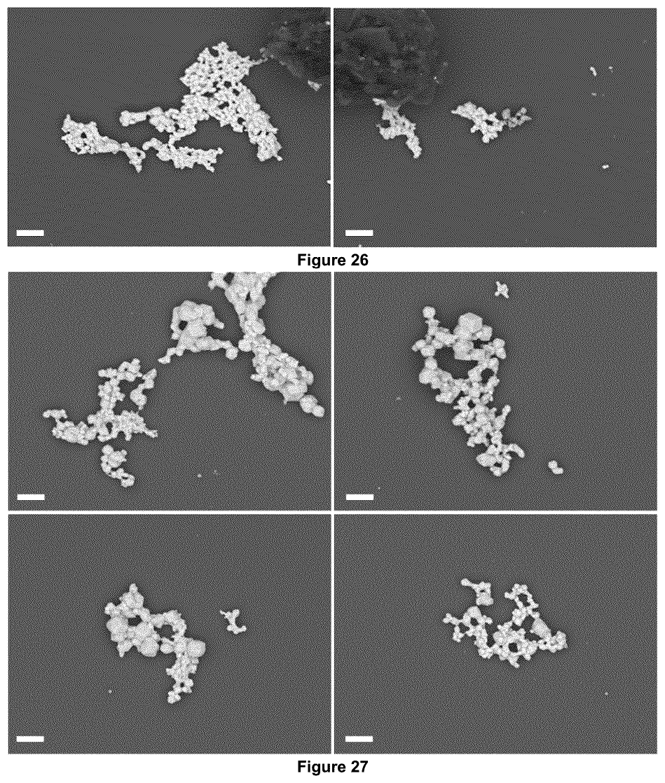

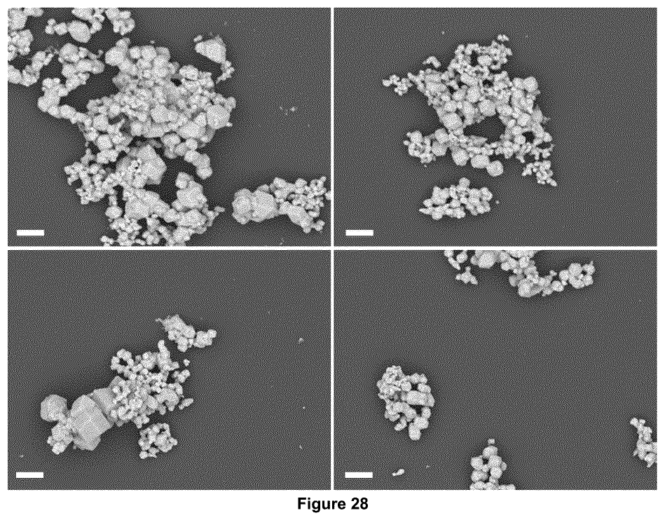

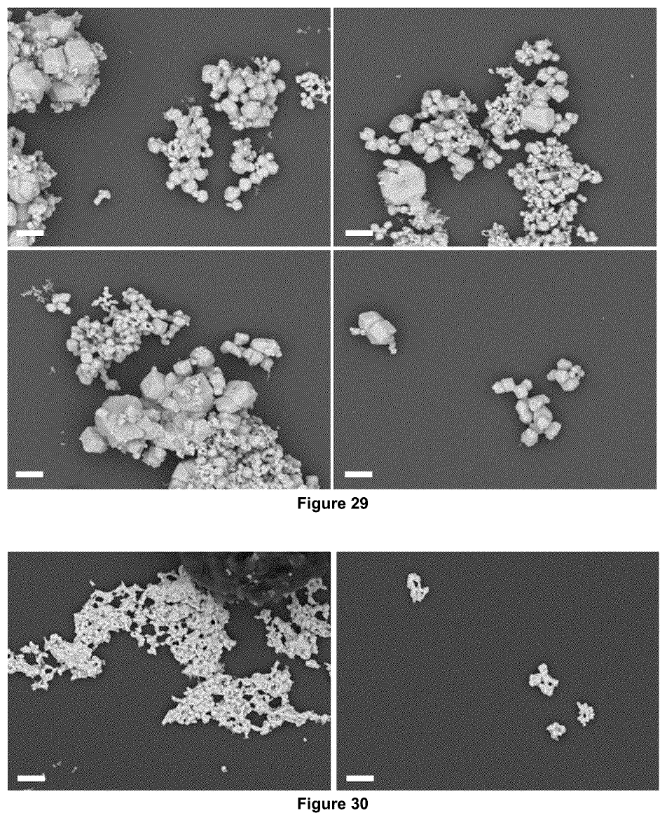

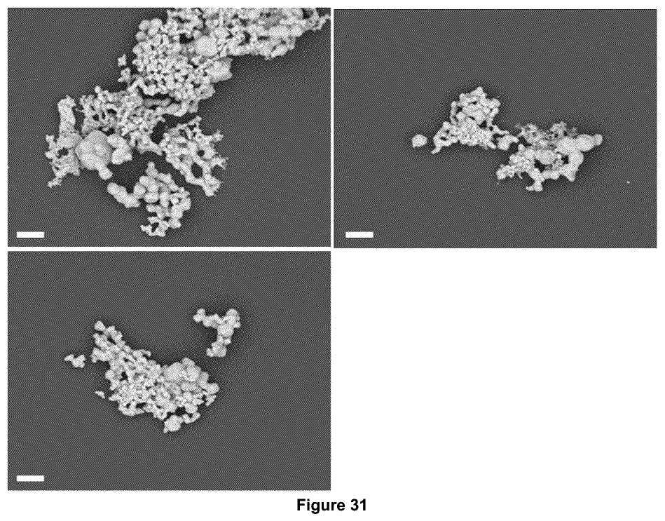

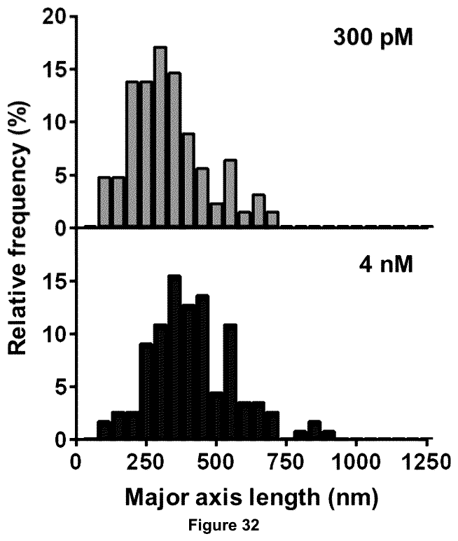

To realize this, several batches of crystals were synthesized where the concentration of seed PAEs was held constant at 150 pM and the concentration of growth PAEs added was between 150 pM and 4 nM. All crystalline products were confirmed to have the expected BCC lattice symmetry (FIG. 25) and rhombic dodecahedral crystal habit (FIG. 5). Each of the samples was analyzed using the Python script and plotted histograms for each of the samples. A clear trend of increasing size corresponding to increasing growth PAE concentration is readily apparent. Indeed, across all samples, a relatively similar standard deviation exists for each of the measured samples, confirming the relatively narrow size distribution that the methods of the disclosure are capable of reproducing. The average crystal size observed via this synthetic approach is smaller than previously reported for homogeneous growth even with quenching to improve size dispersity.

### Crystallizing Multicomponent Core-Shell Colloidal Crystals

The two-step crystallization method of the disclosure can be used to form multicomponent core-shell colloidal crystals using two distinct nanoparticles for the seed and growth PAEs. For example, the first and second nanoparticles can be formed of a different material than the third and fourth nanoparticles. For example, gold and silver nanoparticles can be used.

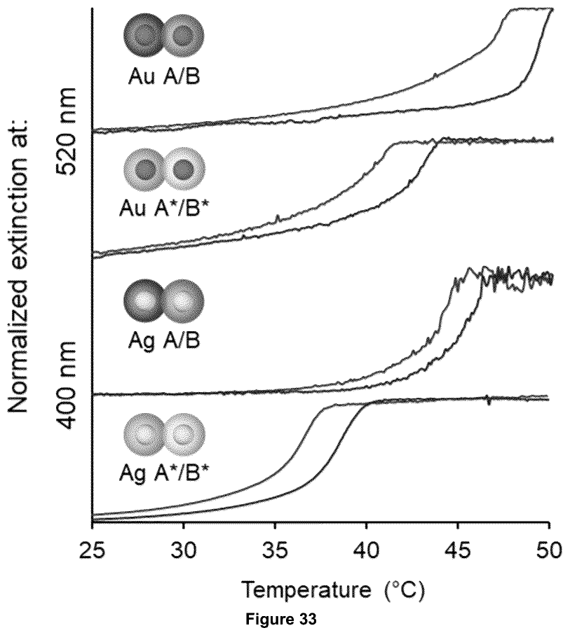

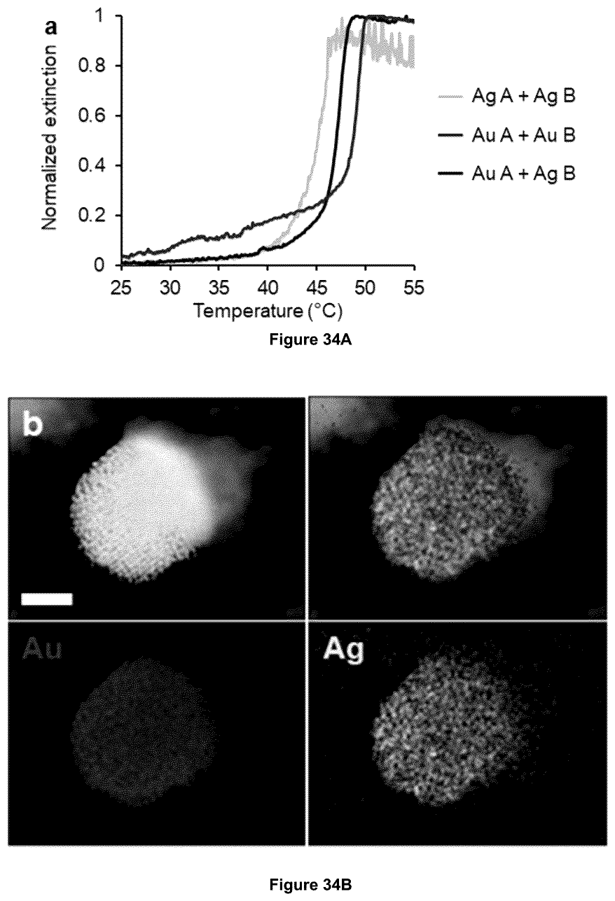

Silver nanoparticles were synthesized according to a previous report to closely match the size of the gold nanoparticles used in the previous experiments. The thiolated DNA used to functionalize gold cores was replaced with a cyclic disulfide in correspondence with previous reports that this functionalization chemistry led to better stability, stronger binding, and improved loading over the single thiol when applied to silver nanoparticles. Silver nanoparticles were functionalized with each of the A, B, A*, and B* DNA designs as described in the table below, and assemblies containing A and B and A* and B* complementary PAEs were characterized using UV-vis to determine their Tₘ (FIG. 33). The use of both silver and gold nanoparticle cores enables the distinct measurement of their absorbance peaks (around 400 nm for silver and around 520 nm for gold) as well as enabling the ability to visualize the exact localization of each particle type within a crystal through energy dispersive X-ray spectroscopy (EDS) during electron microscopy. Control structures of CsCl lattice symmetry consisting of gold nanoparticles with A DNA and complementary silver nanoparticles with B DNA verified the use of these techniques to confirm the presence of PAEs with different cores in the final structure (FIG. 34).

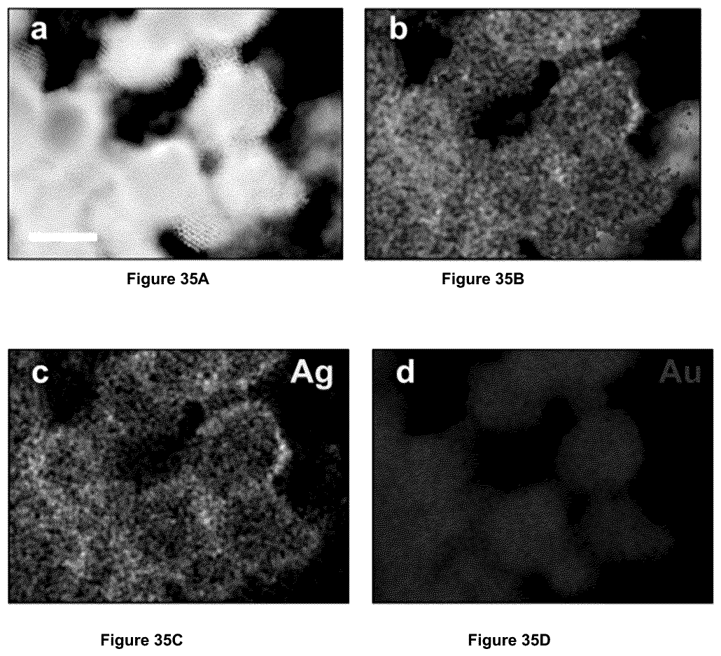

Crystals were then prepared using the gold nanoparticle seed PAEs (first and second oligonucleotide functionalized nanoparticles) and silver nanoparticle growth PAEs (third and fourth oligonucleotide functionalized nanoparticles) (FIG. 6). The crystallization melting curves were measured using UV-vis to monitor the absorbance at both particles' peak wavelengths. A single high temperature transition was observed at the 520 nm wavelength indicating nucleation of the gold PAEs, while the 400 nm wavelength shows a broader transition (FIG. 6B). This 400 nm transition started at higher temperatures than the silver growth PAEs would assemble on their own, consistent with the previous in situ SAXS observations and further supporting the proposed heterogeneous growth mechanism (FIG. 35). Upon silica-stabilization the crystals were imaged using scanning transmission electron microscopy (STEM). EDS maps of the crystals show clearly defined domains of nanoparticle core elements within the single crystals (FIG. 6C). This result clearly demonstrates that the crystallization process with this design occurs in two distinct stages, and that the second step exclusively involves heterogeneous growth on the nucleates formed during the first step. Additionally, the lack of any crystals containing only silver-nanoparticle cores highlights that no significant secondary nucleation is occurring during the second stage of this process (FIG. S36).

In addition to offering additional evidence of the mechanism of the two-step crystallization, this result also demonstrates a generalizable method toward core-shell colloidal crystals. Such crystals have been demonstrated previously but lack the translatability toward multicomponent assembly due to the constraints upon their crystallization or the DNA design. Core-shell nanoparticles have garnered immense interest within nanotechnology as a design to offer greater tunability of properties or enhanced stability conferred by the shell material upon a more delicate core material. Gold core/silver shell colloidal crystal were synthesized in a single step without the need for post-synthetic stabilization or other driving forces during assembly. The methods of the disclosure and use of the oligonucleotide sticky ends enables the crystallization of the core/shell structures to be completely independent of the nanoparticle cores.

The method of the disclosure can and the tunability of the oligonucleotide sticky end interaction strengths (in duplex formation) enables the potential to incorporate additional structural complexity in the form of additional shells. For example, the methods of the disclosure can additional growth PAEs formed from nanoparticles having a different composition as compared to the third and fourth nanoparticles. The additional growth PAEs can be functionalized with oligonucleotides having sticky ends such that a melting point of duplexes formed with these oligonucleotides are tailored to the desired position of shell formation. The oligonucleotides of the additional growth PAEs can have base mismatches such that a resulting melting point of the duplexes is lower than a melting point of the second, third, and fourth duplexes, thereby resulting in crystallization of the additional growth PAEs after a first shell is formed to form a distinct second shell structure.

For example, the method can include admixing seed PAEs, first growth PAEs, and second growth PAEs. The seed PAEs, first growth PAEs, and second growth PAEs can each have different nanoparticles, thereby resulting in a multicomponent crystal having a core defined by the material of the seed PAE nanoparticle, a first shell defined by the material of the first growth PAE nanoparticle, and a second shell defined by the material of the second growth PAE nanoparticle. The method will be described with references to a two-shell structure. However, any suitable number of distinct shell structures can be formed using the principles herein by adding additional growth PAEs of distinct nanoparticles.

The seed PAEs include a first nanoparticle functionalized with a first oligonucleotide, a second nanoparticle functionalized with a second oligonucleotide. The first and second oligonucleotides each have sticky ends that are adapted to hybridize to one another to form a first duplex.

The first growth PAEs can include a third nanoparticle functionalized with a third oligonucleotide and a fourth nanoparticle functionalized with a fourth oligonucleotide. The third oligonucleotide has a sticky end that has at least one base mismatch as compared to the sticky end of the first oligonucleotide. The fourth oligonucleotide has a sticky end that has at least one base mismatch as compared to the sticky end of the second oligonucleotide. The sticky end of the third oligonucleotide is adapted to hybridize to the sticky end of second oligonucleotide to form a second duplex. The sticky end of the fourth oligonucleotide is adapted to hybridize to the sticky end of the first oligonucleotide to form a third duplex. The sticky ends of the third and fourth oligonucleotides are adapted to hybridize to form a fourth duplex.

The second growth PAEs can include a fifth nanoparticle functionalized with a fifth oligonucleotide and a sixth nanoparticle functionalized with a sixth oligonucleotide. The fifth oligonucleotide has a sticky end that has at least two base mismatches as compared to the sticky end of the first oligonucleotide and at least one base mismatch as compared to the sticky end of the third oligonucleotide. The sixth oligonucleotide has a sticky end that has at least two base mismatch as compared to the sticky end of the second oligonucleotide and at least one base mismatch as compared to the sticky end of the fourth oligonucleotide. The sticky end of the sixth oligonucleotide is adapted to hybridize to the sticky end of second oligonucleotide to form a fifth duplex, and to hybridize to the sticky end of the fourth oligonucleotide to form a sixth duplex. The sticky end of the sixth oligonucleotide is adapted to hybridize to the sticky end of the first oligonucleotide to form a seventh duplex, and to hybridize to the sticky end of the third oligonucleotide to form an eighth duplex. The sticky ends of the fifth and sixth oligonucleotides are adapted to hybridize to form a ninth duplex.

The melting temperature of the first duplex is higher than all other duplexes formed by the components of the system. This ensures that during the cooling stages the first and second nanoparticles nucleate as seeds first. The second, third, and fourth duplexes have a higher melting temperature than the first, sixth, seventh, eighth, and ninth duplexes so that the first growth PAEs crystallize on the seeds to form a first shell before the second growth PAEs nucleate.

The method of forming the multi-component structure includes at least three cooling stages. A first cooling stage performed at a temperature lower than the melting temperature of the first duplex, but higher than the melting temperature of all other duplexes formed by the component such that the first and second nanoparticles nucleate and form seeds in the solution. The method includes a second cooling stage performed at a temperature lower than the melting temperature of the second, third, and fourth duplexes, but higher than the fifth through ninth duplexes, such that the first growth PAEs crystallize on the seeds forming the first shell. Finally, the method includes a third cooling stage performed at a temperature lower than the melting temperature of the fifth through ninth duplexes such that the second growth PAEs crystallize on the first shell and form the second shell. Additional cooling stages can be implemented as needed depending on the number of distinct growth PAEs present in solution and the resulting number of distinct shell structures to be formed.

### Examples

### Materials

DNA synthesis reagents were purchased from Glen Research. Gold nanoparticles were purchased from Ted Pella. Silver nitrate, triethoxysilane (TES), NaCl, NaH₂PO₄, Na2HPO4, sodium dodecyl sulfate (SDS), tannic acid, and trisodium citrate were purchased from Sigma Aldrich. N-trimethoxysilylpropyl-N,N,N-trimethylammonium chloride (TMSPA) was purchased from Gelest.

### DNA Sequence Design

DNA strand designs used in this work consist of an “anchor” strand bound to the nanoparticle surface and a “linker” strand with an 18 bp region complementary to an anchor strand followed by a 6-8 bp sticky end responsible for hybridization between neighboring PAEs that drives assembly. This work required 4 distinct anchor and linker recognition region sequences to prevent rearrangement of DNA linkers between seed and growth PAEs in the complementary system. Sticky end sequences were designed such that the complementary A+B seed sequences had a 7 bp overlap, while complementary A*+B* growth sequences had a since base mismatch resulting in a weaker, 6 bp interaction. The other possible A+B* and A*+B interactions likewise had a single base mismatch to facilitate a weaker interaction strength. In the case of the cube PAEs with self-complementary DNA, longer linker strands were used. These consisted of the standard 18 bp recognition regions followed by two 20 bp regions complementary to a “duplexer” strand before the sticky end. Interaction strength of the self-complementary sticky ends was modulated by changing the sequence length, with 6 or 8 bp respectively. NUPACK was used to design new strands to prevent secondary structure or unwanted complementarity for the new 8 strand system.

### DNA Synthesis

Oligonucleotides were synthesized at a 5 μmol scale on an automated MerMade 12 synthesizer (BioAutomation). Universal controlled pore glass (CPG) beads were used as the solid support for linker DNA strands, while 3′ thiol and 3′ dithiol CPGs were used for AuNP and AgNP anchor strands, respectively. Oligonucleotides were cleaved from the solid support according to manufacturer protocols and contained a 5′ DMT group to facilitate purification via reversed-phase HPLC. Purified strands were treated with acid deprotection and extracted with ethyl acetate. Matrix-assisted laser desorption ionization time-of-flight mass spectrometry (MALDI-TOF, Bruker) was used to confirm the molecular weight of oligonucleotides, while UV-vis spectroscopy (Agilent) was used to quantify the concentration. Extinction coefficients were calculated for 260 nm using the OligoAnalyzer tool (Integrated DNA Technologies).

TABLE 1
DNA sequences
Anchor strands used for Au spheres (5′ → 3′)

| | | |
|---|---|---|
| Anchor A | TCA ACT ATC TCT AGC TAC Sp18₂ SH | (SEQ ID NO: 1) |
| Anchor B | TCC ACT CAT ACT CAG CAA Sp18₂ SH | (SEQ ID NO: 2) |
| Anchor A* | CAT TAC ACA GTC ATA TCA Sp18₂ SH | (SEQ ID NO: 3) |
| Anchor B* | ATG CCT ACT TAC GAT TTA Sp18₂ SH | (SEQ ID NO: 4) |

Anchor strands used for Ag spheres (5′ → 3′)

| | | |
|---|---|---|
| Anchor A | TCA ACT ATC TCT AGC TAC Sp18₂ dithiol | (SEQ ID NO: 5) |
| Anchor B | TCC ACT CAT ACT CAG CAA Sp18₂ dithiol | (SEQ ID NO: 6) |
| Anchor A* | CAT TAC ACA GTC ATA TCA Sp18₂ dithiol | (SEQ ID NO: 7) |
| Anchor B* | ATG CCT ACT TAC GAT TTA Sp18₂ dithiol | (SEQ ID NO: 8) |

Complementary linker strands for Au and Ag spheres (5′ → 3′)

| | | |
|---|---|---|
| Linker A | GTA GCT AGA GAT AGT TGA Sp18 TTTCCTT | (SEQ ID NO: 9) |
| Linker B | TTG CTG AGT ATG AGT GGA Sp18 AAGGAAA | (SEQ ID NO: 10) |
| Linker A* | TGA TAT GAC TGT GTA ATG Sp18 ATTCCTT | (SEQ ID NO: 11) |
| Linker B* | TAA ATC GTA AGT AGG CAT Sp18 AAGGAAC | (SEQ ID NO: 12) |

*Sp18 is Spacer 18

### Au Sphere Functionalization

Au nanoparticles were functionalized according to literature procedures. Briefly, anchor DNA strands were reduced with 100 mM TCEP and desalted using NAP10 columns prior to addition to Au nanoparticles. Salt aging was used to increase the DNA functionalization density by slow additions of 2 M NaCl to a final concentration of 0.5 M over the course of ˜4 hours. Nanoparticles with DNA were incubated at room temperature overnight following salt aging, and excess unbound DNA was removed via three rounds of spin filtration with 50 kDa filters (Amicon). Au PAE concentrations were quantified by UV-vis using extinction coefficients from the manufacturer. Au nanoparticles with 15 and 20 nm diameters were used.

### Ag Sphere Synthesis and Functionalization

Silver nanoparticles were synthesized based on an adapted protocol from Bastús et al.¹ Briefly, a 100 mL solution of 5 mM trisodium citrate and 25 μM tannic acid was heated to reflux in a three-neck round-bottom flask outfitted with a condenser using a heating mantle. The solution boiled for 15 minutes while stirring vigorously. Then, a 1 mL volume of 25 mM sodium nitrate was rapidly injected into the flask causing the color to change to bright yellow immediately. The solution was boiled under vigorous stirring for another 15 minutes before being removed from the heat. The solution was then centrifuged at 20,000 g for 40 minutes, washed with 2.2 mM sodium citrate solution, and then centrifuged again. The particles were stored in 2.2 mM sodium citrate, wrapped in foil, and incubated at 4° C. TEM and UV-Vis were used to characterize the size, absorbance, and concentration of the particles.

Ag nanoparticles were functionalized with a modified salt aging procedure to maximize DNA loading, as DNA loading for Ag compared to Au nanoparticles can result in lower loading or less stable constructs. 3′ dithiol-modified anchor strands were added directly to purified Ag nanoparticles and incubated overnight at 4° C. in the dark. A modified salt aging procedure was used with additions of 2 M NaCl up to a final concentration of 1 M. Nanoparticles with DNA were sonicated for 10 minutes after each salt addition, and finally incubated in the dark at 4° C. for 48 hours before purification. Excess DNA strands were removed via three rounds of spin filtration with 50 kDa filters. Ag PAE concentrations were quantified via inductively-coupled plasma optical emission spectroscopy (ICP-OES).

### UV-Vis Melting Experiments

Thermal UV-vis experiments using a Cary 5000 UV-vis-NIR spectrometer were used to characterize the melting temperature of assemblies with different DNA designs. Assembly solutions were prepared with a total volume of 1 mL containing 1 nM spherical PAEs, 0.6 μM linker DNA strands, 0.5 M NaCl, 2.5 mM phosphate buffer (pH=7.4) in quartz cuvettes with magnetic stirring. Solutions were heated to above their melting temperature (typically starting at 60° C.) and cooled at a rate of 0.2° C./min to 15° C., and then heated back to the starting temperature at the same rate. Extinction at the LSPR of the nanoparticle core was collected each minute throughout the heating and cooling process. Pairs of Au spheres with complementary DNA combinations (A+B, A*+B*, A+B*, A*+B) were first combined in a 1:1 ratio and characterized with detection at 520 nm. Seeded growth was characterized for Au spheres with a 1:2 ratio of A/B:A*/B* PAEs at the same wavelength. Coassemblies of Au and Ag spheres were characterized by repeating the thermal UV-vis experiment on the same sample with detection at 400 nm for the Ag spheres followed by 520 nm for Au.

### Colloidal Crystallization

100 μL assembly solutions were prepared with 0.5 NaCl and 2.5 mM phosphate buffer (pH=7.4) assembly buffer. DNA linkers were added for each type of PAE at a rate of 1200 strands per particle. Thermal cyclers (Bio Rad) were used to program a slow cooling rate, typically cooling from 5-10° above the highest PAE melting temperature at a rate of 0.1° C./10 min.

Colloidal crystals were assembled using 15 nm PAEs with a 200 pM concentration of seed PAEs and 1 nM total PAE concentration to compare crystal uniformity. A hold temperature of 35° C. was used based on the UV-vis melting temperature, while control assemblies without a temperature hold and only containing A*+B* PAEs were also assembled.

To study the effect of the 12 hour temperature hold during the slow cooling procedure, temperature gradient steps were programmed on the thermal cyclers to characterize crystals assembled with hold temperatures at 45.5, 44.3, 41.9, 39.5, 39, 38.3, and 37.3° C. All crystallization solutions had a seed PAE concentration of 200 pM and total PAE concentration of 1 nM using 20 nm Au PAEs.

Colloidal crystals with different sizes were assembled by varying the total concentration of 15 nm Au PAEs from 300 μm, 1 nM, 2.5 nM, and 4 nM. The seed PAE concentration was consistent at 150 pM in each of the assemblies, and a 34.5° C. hold temperature was used.

Core-shell colloidal crystals were assembled from a solution containing 200 pM A and B PAEs with a 20 nm Au nanoparticle core and 800 pM A* and B* PAEs with the synthesized Ag nanoparticle cores. Standard slow cooling without a temperature hold was used in these crystallizations.

### Small-Angle X-Ray Scattering (SAXS)

The Dupont-Northwestern-Dow Collaborative Access Team beamline at sector 5 of the Advanced Photon Source at Argonne National Laboratory was used for all SAXS experiments. The X-ray wavelength used was 1.24 Å (10 keV) with two sets of slits used to collimate the beam. The detector geometry was calibrated with silver behenate and silicon diffraction grating standards. 1.5 mm quartz capillary tubes (Charles Supper) were used for SAXS samples. Samples were placed in the beam's path for between 0.1 to 1 s for typical SAXS patterns and scattering was measured with a CCD area detector. In situ SAXS experiments used a Linkam thermal stage to cool samples at a rate of 0.2° C./min from 55-25° C. Samples were exposed for 0.2 s at 5 min intervals throughout the cooling procedure. 2D patterns were azimuthally averaged to plot a 1D pattern of intensity, I(q), in log scale vs. the scattering vector, q. Contributions to scattered intensity include the capillary and buffer, which are considered negligible compared to other contributions, the form factor due to the shape and size of the underlying nanoparticle cores, and the structure factor. Plots showing structure factor, S(q), vs. q have the form factor contribution removed by dividing I(q) by that of an unassembled nanoparticle control. Experimental peaks were compared to simulated 1D SAXS patterns to confirm lattice symmetry and lattice parameter.

### Stabilization of Colloidal Crystals

Colloidal crystals were stabilized for electron microscopy characterization using two methods. Au PAE assemblies with both spheres and cubes were stabilized using the Ag⁺ ion method. After colloidal crystallization, assembly buffer containing any unbound DNA or unassembled PAEs was removed and replaced with 0.5 M NaClO₄. Buffer replacement was carried out 3 times and a final volume of 1 mL of 0.5 M AgNO₃ was added. Samples were incubated at room temperature overnight and then washed 3 times with Milli-Q water. Colloidal crystals containing Ag PAEs were instead transferred to the solid state via silica embedding. The total volume of assembled samples was increased to 1 mL in 0.5 M NaCl assembly buffer and 2 μL of TMSPA were added. Samples were incubated at room temperature with shaking for at least 20 minutes, followed by addition of 4 μL TES. After shaking overnight silica encapsulated crystals were collected via microcentrifugation and washed 3 times with Milli-Q water.

### Electron Microscopy

Stabilized colloidal crystals were drop-cast on plasma-treated silicon wafers or carbon-coated copper mesh grids (Ted Pella) for scanning electron microscopy (SEM) or scanning transmission electron microscopy (STEM), respectively. SEM characterization of crystal habit was carried out on a JEOL JSM-7900FLV microscope at 6 kV accelerating voltage and backscattered electron detection. Imaging for use in automated size analysis was done at a consistent magnification of 10000×. A Hitachi HD-2300A STEM with dual EDS detectors was used for EDS mapping. An accelerating voltage of 200 kV for z-contrast imaging was used, while a 15 minute acquisition time with drift compensation was used for elemental mapping. Noran System 7 (Thermo Scientific) was used to acquire and process EDS maps.

### Image Analysis

A Python script for image analysis was developed for the purposes of accurately and quickly measuring colloidal crystal size distribution. The use of an automated script allows for analysis of larger datasets, faster processing speeds, and most importantly decreases the potential for human bias during the measurement process. Colloidal crystals were embedded with silver ions to avoid any obstructing aggregates from silica. All images were taken at 10,000× magnification. Then, the image was prepared for a watershed algorithm analysis. The watershed algorithm was selected to account for imaging features characteristic to SEM images of colloidal crystals. This method differs from previously automated approaches to nanoparticle size analysis for these reasons as well.

First, colloidal crystal samples are often overlapping or adjacent when dried for SEM analysis such that edge detection or thresholding cannot separate regions. Second, the rhombic dodecahedral crystal habits had mainly 3 distinct 2D projections although any orientation is also possible, so a program cannot rely purely on shape detection as a means of identifying crystals. Along these lines, crystals also have much lower uniformity and quality than nanoparticles which would further complicate shape identification algorithms. A watershed algorithm circumvents some of these issues by characterizing a grayscale image as a topological surface, identifying local minima and maxima of the image, and labeling these regions as boundaries and regions, respectively. The watershed algorithm from OpenCV (Open Source Computer Vision Library: http://opencv.org) was used. After the regions are identified, the regionprops algorithm from scikit-image (scikit-image.org) was used to measure crystal sizes. The python script was written in Jupyter Notebook.

This methodology and code are well established and closely follow the OpenCV documentation chapter entitled “Image Segmentation with Watershed Algorithm.” First, the program cropped the scale bar from the image (so that only crystals would be analyzed) and thresholded to a binary image. Then, to avoid over-segmentation of background artifacts or incorrect boundary drawing when applying the watershed algorithm, a distance transform function was utilized to indicate regions of crystal, background, and “unknown” regions. In the distance transform function (OpenCV), each pixel value is replaced with a value corresponding to the distance from the thresholded boundary; this essentially provides a topographic map. After redefining the image array with values from the distance transform, the computer was instructed what range of values correspond to either foreground (crystal), background, or “unknown” (boundary region). Finally, the watershed algorithm can be applied to draw final boundaries. After regions have been determined by the computer, the image can be analyzed by scikit-image regionprops algorithm to extract a variety of measurement values for each region and exported to a csv file. The code used for the image analysis operates completely independently of any crystal shape and can therefore be used to analyze the sizes of any sample.

Although automated labeling and measurement is much faster and less biased than hand measurements, the program can still misclassify crystals. Examples of these misclassifications include fused crystals, nonspecific aggregates, or even true crystals that the watershed algorithm couldn't bound correctly, all of which skew measurements. In order to filter these misclassifications, a series of criteria established from the measurements to quantify shape irregularity were applied post image measurement. The criteria chosen were specific to the expected rhombic dodecahedral crystal shapes and would not necessarily be directly translatable to other crystal habits. Any object that did not meet the established criteria was removed from the dataset. Major axis length was the parameter used to compare crystal size distributions.

Finally, measurements from the program and thresholding were compared to hand measurements on a single micrograph image. This would help us to understand if the automated measurements were yielding reasonable size values and accurately classifying crystals through the thresholding. Hand measurement (and classification) identified 104 crystals to be measured compared to 91 crystals measured and filtered by the program. Size distributions were 543±140 nm and 554±190 nm for hand measurements and program measurements respectively. The thresholding criteria is a very simplistic means of classifying objects from images either as “crystal” or “not a crystal” that eventually points to the opportunity for a more rigorous machine learning classification model. With this perspective in mind, a confusion matrix for one sample image (n=164) was constructed in order to assess the performance of this preliminary two-class classification model. From the image, 68 crystals were identified and measured both by hand and with the program, yielding a classifier accuracy of 63%. Considering that the classification was only done with a series of threshold values as opposed to teaching an algorithm based on a training set, this accuracy is very reasonable for the purposes of this work. It was observed from the confusion matrix that the program counted much fewer false positives (23) compared to the number of false negatives (37). This indicates that the low classification accuracy is due more to false negatives (i.e. determining what is “not a crystal”); since accurate measurement data of “true crystals” is the goal of the program in this work, incorrectly removing a few “true crystals” from the dataset will not sacrifice or skew size distributions. The largest discrepancy between the computer classification and human classification was usually a result of poor segmentation. This resulted in a large object that did not pass the criteria removing it from the data set, while a human might have measured it as two or more individual crystals.

The use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict embodiments for purposes of illustration only. One of ordinary skill in the art will readily recognize from the following discussion that alternative embodiments of the structures and methods illustrated herein may be employed without departing from the principles described herein.

Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.
(1) N. G. Bastús, F. Merkoçi, J. Piella, V. Puntes, Chemistry of Materials 2014, 26 (9), 2836-2846.
(2) O. G. Hayes, J. R. McMillan, B. Lee, C. A. Mirkin, Journal of the American Chemical Society 2018, 140 (29), 9269-9274.
(3) T. Oh, S. S. Park, C. A. Mirkin, Advanced Materials 2019, 31 (1), 1805480.
(4) E. Auyeung, R. J. Macfarlane, C. H. J. Choi, J. I. Cutler, C. A. Mirkin, Advanced Materials 2012, 24 (38), 5181-5186.
(5) M. N. O'Brien, M. R. Jones, K. A. Brown, C. A. Mirkin, Journal of the American Chemical Society 2014, 136 (21), 7603-7606.
(1) D. Samanta, W. Zhou, S. B. Ebrahimi, S. H. Petrosko, C. A. Mirkin, Advanced Materials 2022, 34(12), 2107875.
(2) Y. Hao, M. Kristiansen, R. Sha, J. J. Birktoft, C. Hernandez, C. Mao, N. C. Seeman, Nature chemistry 2017, 9 (8), 824-827.
(3) W. Liu, H. Zhong, R. Wang, N. C. Seeman, Angewandte Chemie International Edition 2011, 50 (1), 264-267.
(4) C. R. Laramy, M. N. O'Brien, C. A. Mirkin, Nature Reviews Materials 2019, 4 (3), 201-224.
(5) E. Auyeung, T. I. N. G. Li, A. J. Senesi, A. L. Schmucker, B. C. Pals, M. O. De La Cruz, C. A. Mirkin, Nature 2014, 505 (7481), 73-77.
(6) S. E. Seo, M. Girard, M. Olvera de la Cruz, C. A. Mirkin, Nature Communications 2018, 9 (1), 4558.
(7) S. S. Park, Z. J. Urbach, C. A. Brisbois, K. A. Parker, B. E. Partridge, T. Oh, V. P. Dravid, M. Olvera De La Cruz, C. A. Mirkin, Advanced Materials 2020, 32 (4), 1906626.
(8) K. M. Landy, K. J. Gibson, Z. J. Urbach, S. S. Park, E. W. Roth, S. Weigand, C. A. Mirkin, Nano Letters 2022.
(9) E. V. Shevchenko, D. V. Talapin, N. A. Kotov, S. O'Brien, C. B. Murray, Nature 2006, 439 (7072), 55-59.
(10) F. X. Redl, K.-S. Cho, C. B. Murray, S. O'Brien, Nature 2003, 423 (6943), 968-971.
(11) M. A. Boles, M. Engel, D. V. Talapin, Chemical Reviews 2016, 116 (18), 11220-11289.
(12) J. Zhuang, H. Wu, Y. Yang, Y. C. Cao, Journal of the American Chemical Society 2007, 129 (46), 14166-14167.
(13) B. de Nijs, S. Dussi, F. Smallenburg, J. D. Meeldijk, D. J. Groenendijk, L. Filion, A. Imhof, A. van Blaaderen, M. Dijkstra, Nature Materials 2015, 14 (1), 56-60.
(14) S. M. Rupich, E. V. Shevchenko, M. I. Bodnarchuk, B. Lee, D. V. Talapin, Journal of the American Chemical Society 2010, 132 (1), 289-296.
(15) J. Hao, Y. Yang, F. Zhang, Z. Yang, J. Wei, The Journal of Physical Chemistry C 2020, 124 (27), 14775-14786.
(16) D. J. Lewis, L. Z. Zornberg, D. J. Carter, R. J. Macfarlane, Nature Materials 2020, 19 (7), 719-724.
(17) T. Oh, J. C. Ku, J.-H. Lee, M. C. Hersam, C. A. Mirkin, Nano Letters 2018, 18 (9), 6022-6029.
(18) P. J. Santos, P. A. Gabrys, L. Z. Zornberg, M. S. Lee, R. J. Macfarlane, Nature 2021, 591 (7851), 586-591.
(19) S. Kim, C. Y. Zheng, G. C. Schatz, K. Aydin, K.-H. Kim, C. A. Mirkin, Nano Letters 2020, 20 (11), 8096-8101.
(20) L. Sun, H. Lin, D. J. Park, M. R. Bourgeois, M. B. Ross, J. C. Ku, G. C. Schatz, C. A. Mirkin, Nano Letters 2017, 17(4), 2313-2318.
(21) J.-H. Lee, K. J. Gibson, G. Chen, Y. Weizmann, Nature Communications 2015, 6 (1), 7571.
(22) L. Scarabelli, M. Coronado-Puchau, J. J. Giner-Casares, J. Langer, L. M. Liz-Marzán, ACS nano 2014, 8 (6), 5833-5842.
(23) X. Ye, C. Zheng, J. Chen, Y. Gao, C. B. Murray, Nano Letters 2013, 13 (2), 765-771.
(24) N. R. Jana, L. Gearheart, C. J. Murphy, Advanced Materials 2001, 13 (18), 1389-1393.
(25) T. K. Sau, C. J. Murphy, Journal of the American Chemical Society 2004, 126 (28), 8648-8649.
(26) V. K. LaMer, R. H. Dinegar, Journal of the American Chemical Society 1950, 72 (11), 4847-4854.
(27) L. Sun, H. Lin, Y. Li, W. Zhou, J. S. Du, C. A. Mirkin, Advanced Materials 2020, 32 (47), 2005316.
(28) A. J. Senesi, D. J. Eichelsdoerfer, R. J. Macfarlane, M. R. Jones, E. Auyeung, B. Lee, C. A. Mirkin, Angewandte Chemie 2013, 125 (26), 6756-6760.
(29) D. J. Lewis, D. J. Carter, R. J. Macfarlane, Journal of the American Chemical Society 2020, 142(45), 19181-19188.
(30) J. Macfarlane Robert, B. Lee, R. Jones Matthew, N. Harris, C. Schatz George, A. Mirkin Chad, Science 2011, 334 (6053), 204-208.
(31) M. N. O'Brien, K. A. Brown, C. A. Mirkin, ACS Nano 2016, 10 (1), 1363-1368.
(32) N. G. Bastús, F. Merkoçi, J. Piella, V. Puntes, Chemistry of Materials 2014, 26 (9), 2836-2846.
(33) J.-S. Lee, A. K. R. Lytton-Jean, S. J. Hurst, C. A. Mirkin, Nano Letters 2007, 7(7), 2112-2115.
(34) O. G. Hayes, J. R. McMillan, B. Lee, C. A. Mirkin, Journal of the American Chemical Society 2018, 140 (29), 9269-9274.
(35) S. J. Hurst, H. D. Hill, R. J. Macfarlane, J. Wu, V. P. Dravid, C. A. Mirkin, Small 2009, 5 (19), 2156-2161.

What is claimed is:

1. A method for two stage synthesis of colloidal crystals, comprising
admixing in solution a first nanoparticle functionalized with a first oligonucleotide, a second nanoparticle functionalized with a second oligonucleotide, a third nanoparticle functionalized with a third oligonucleotide, and a fourth nanoparticle functionalized with a fourth oligonucleotide, wherein the first and second oligonucleotides have sticky ends that are adapted to hybridize to form a first duplex, the third oligonucleotide has a sticky end adapted to hybridize to the sticky end of second oligonucleotide to form second duplex and has at least one base mismatch as compared to the sticky end of the first oligonucleotide, the fourth oligonucleotide has a sticky end adapted to hybridize to the sticky end of the first oligonucleotide to form a third duplex and has at least one base mismatch as compared to the sticky end of the second oligonucleotide, and sticky ends of the third and fourth oligonucleotides are adapted to hybridize to form a fourth duplex;
inducing seed formation by a first stage cooling under conditions sufficient to cause the first duplex to form resulting in nucleation of seeds formed of the first and second nanoparticles; and
inducing growth on the seeds by a second stage cooling under conditions sufficient to cause one or more of the second, third, and fourth duplexes to form resulting in crystallization on the seeds to thereby grow the colloidal crystals on the seeds, wherein:
a melting temperature of the first duplex is higher than a melting temperature of the second, third, and fourth duplexes,
a temperature during the first stage cooling is at or lower than the melting temperature of the first duplex and higher than the melting temperature of each of the second, third, and fourth duplexes,
a temperature during the second stage cooling is at or lower than the melting temperature of one or more of the second, third, and fourth duplexes.

2. The method of claim 1, wherein the nanoparticles of the first and/or second oligonucleotide-functionalized nanoparticles are metal.

3. The method of claim 2, wherein the nanoparticles are gold.

4. The method of claim 1, wherein the nanoparticles of the first and/or second oligonucleotide-functionalized nanoparticle comprise one or more of magnetic nanoparticles, dielectric nanoparticles, and quantum dots.

5. The method of claim 1, wherein each of the first, second, third, and fourth oligonucleotides comprises an anchor sequence and a linker sequence.

6. The method of claim 1, further comprising forming the first, second, third, and fourth oligonucleotides by admixing a first nanoparticle functionalized with a first anchor oligonucleotide, a second nanoparticle functionalized with a second anchor oligonucleotide, a third nanoparticle functionalized with a third anchor oligonucleotide, and a fourth nanoparticle functionalized with the fourth anchor oligonucleotide, a first linker oligonucleotide, a second linker oligonucleotide, a third linker oligonucleotide, and a fourth linker oligonucleotide, wherein the first anchor oligonucleotide and the first linker oligonucleotide hybridize to form the first nanoparticle functionalized with the first oligonucleotide, the second anchor oligonucleotide and the second linker oligonucleotide hybridize to form the second nanoparticle functionalized with the second oligonucleotide, the third anchor oligonucleotide and the third linker oligonucleotide hybridize to form the third nanoparticle functionalized with the third oligonucleotide, and the fourth anchor oligonucleotide and the fourth linker oligonucleotide hybridize to form the fourth nanoparticle functionalized with the fourth oligonucleotide.

7. The method of claim 6, wherein the first, second, third, and fourth linkers are admixed at a rate of about 1000 to 2000 strands per nanoparticle.

8. The method of claim 1, wherein the first stage cooling comprises cooling from an initial temperature to a temperature higher than the temperature of the second cooling stage at a rate of 0.01° C./min to about 0.2° C./min.

9. The method of claim 1, comprising cooling in the first and second stage cooling at a rate of about 0.1° C./min to about 0.2° C./min.

10. The method of claim 1, wherein the second stage cooling comprises holding at a temperature below the melting temperature of the second, third, and fourth duplexes.

11. The method of claim 10, wherein the temperature is held for about 12 hours.

12. The method of claim 1, wherein a ratio of a concentration of first and second nanoparticles functionalized with the first and second oligonucleotides, respectively, to a concentration of the third and fourth nanoparticles functionalized with the third and fourth oligonucleotides, respectively, is about 1:1 to 3:80.

13. The method of claim 1, wherein cooling comprises reducing the temperature continuously from an initial temperature to through a temperature for the first stage cooling and through a temperature of the second stage cooling.

14. A method for synthesis of colloidal crystals with a core-shell structure, comprising
admixing in solution a first nanoparticle functionalized with a first oligonucleotide, a second nanoparticle functionalized with a second oligonucleotide, a third nanoparticle functionalized with a third oligonucleotide, a fourth nanoparticle functionalized with a fourth oligonucleotide, a fifth nanoparticle functionalized with a fifth oligonucleotide, a sixth nanoparticle functionalized with a sixth oligonucleotide, wherein
the first and second oligonucleotides have sticky ends that are adapted to hybridize to form a first duplex,
the third oligonucleotide has a sticky end adapted to hybridize to the sticky end of second oligonucleotide to form second duplex and has at least one base mismatch as compared to the sticky end of the first oligonucleotide,
the fourth oligonucleotide has a sticky end adapted to hybridize to the sticky end of the first oligonucleotide to form a third duplex and has at least one base mismatch as compared to the sticky end of the second oligonucleotide,
the sticky ends of the third and fourth oligonucleotides are adapted to hybridize to form a fourth duplex,
the fifth oligonucleotide has a sticky end adapted to hybridize to the sticky end of the second oligonucleotide to form a fifth duplex and to the sticky end of the fourth oligonucleotide to form a sixth duplex, and has at least two base mismatches as compared to the sticky end of the first oligonucleotide and at least one base mismatch as compared to the sticky end of the third oligonucleotide,
the sixth oligonucleotide has a sticky end adapted to hybridize to the sticky end of the first oligonucleotide to form a seventh duplex and to the sticky end of the third oligonucleotide to form an eight duplex, and has at least two bae mismatches as compared to the sticky end of the second oligonucleotide and at least one base mismatch as compared to the sticky end of the fourth oligonucleotide
the sticky ends of the fifth and sixth oligonucleotides are adapted to hybridize to form a ninth duplex;
inducing seed formation by a first stage cooling under conditions sufficient to cause the first duplex to form resulting in nucleation of seeds formed of the first and second nanoparticles; and
inducing a first shell growth on the seeds by a second stage cooling under conditions sufficient to cause one or more of the second, third, and fourth duplexes to form resulting in crystallization on the seeds to thereby grow the first shell on the seeds,
inducing a second shell growth on the first shell by a third stage cooling under conditions sufficient to cause one or more of the fifth, sixth, seventh, eighth, and ninth duplexes to form resulting in crystallization on the first shell to thereby grow a second shell, wherein:
a melting temperature of the first duplex is higher than a melting temperature of the second, third, fourth, fifth, sixth, seventh, eighth, and ninth duplexes,
a temperature during the first stage cooling is at or lower than the melting temperature of the first duplex and higher than the melting temperature of each of the second, third, fourth, fifth, sixth, seventh, eighth, and ninth duplexes,
a temperature during the second stage cooling is at or lower than the melting temperature of one or more of the second, third, and fourth duplexes and higher than a melting temperature of each of the fifth, sixth, seventh, eighth, and ninth duplexes, and
a temperature during the third stage cooling is lower than a melting temperature of one or more of the fifth, sixth, seventh, eighth, and ninth duplexes.

15. The method of claim 14, wherein the first and second nanoparticles are formed of a different material than the third and fourth nanoparticles and the third and the third and fourth nanoparticles are formed of a different material than the fifth and sixth nanoparticles.

16. The method of claim 15, wherein the first and second nanoparticles are formed of a different material than the fifth and sixth nanoparticles.

17. The method of claim 14, wherein the first, second, third, fourth, fifth, sixth, seventh, eighth, and ninth nanoparticle are independently selected from magnetic nanoparticles, dielectric nanoparticles, and quantum dots.

18. The method of claim 14, wherein the first, second, third, fourth, fifth, sixth, seventh, eighth, and ninth nanoparticle are each metals.
